(19) United States
(12) Patent Application Publication
(10) Pub. No.: US 2026/0251996 A1
(43) Pub. Date: Aug. 27, 2026

(54) LIGHT SCANNING APPARATUS AND IMAGE FORMING APPARATUS INCLUDING THE SAME

(71) Applicant: CANON KABUSHIKI KAISHA, Tokyo (JP)

(72) Inventors: KAZUMI KIMURA, Saitama (JP); HIROKI YOSHIDA, Tochigi (JP); TOSHIFUMI CHIDA, Tochigi (JP); HIROYUKI FUKUHARA, Shizuoka (JP); HIROKI KATAYAMA, Shizuoka (JP)

(21) Appl. No.: 19/548,165

(22) Filed: Feb. 24, 2026

(30) Foreign Application Priority Data
Feb. 27, 2025 (JP) 2025-029685

(51) Int. Cl. G03G 15/041; B41J 2/447; B41J 2/47; G02B 26/12; G03G 15/01; G03G 15/04

(52) U.S. Cl. CPC G03G 15/0415; B41J 2/447; B41J 2/473; G02B 26/124; G03G 15/011; G03G 15/0194; G03G 15/04036

(57) ABSTRACT

An apparatus includes a deflecting unit including a first deflecting surface configured to deflect first and second light fluxes from first and second light sources to scan first and second surfaces in a main scanning direction, respectively, and first and second light guiding units configured to guide the first and second light fluxes from the first and second light sources to the first deflecting surface, respectively. An optical path of the first light flux in the first light guiding unit includes a straight line connecting the first light source and the first deflecting surface. An optical path of the second light flux in the second light guiding unit does not include a straight line connecting the second light source and the first deflecting surface.

### BACKGROUND

### Field of the Technology

The aspect of the embodiments is related to a light scanning apparatus, and more particularly to a light scanning apparatus suitably used in an image forming apparatus such as a laser beam printer or a multi-function printer having an electrophotographic process.

### Description of the Related Art

Japanese Patent Laid-Open No. 2023-083744 discloses a light scanning apparatus in which a plurality of collimator lenses can be arranged so as to be gripped from the same direction to adjust relative positions between the plurality of collimator lens and a plurality of light sources at the time of manufacturing.

### SUMMARY

An apparatus includes a deflecting unit including a first deflecting surface configured to deflect first and second light fluxes from first and second light sources to scan first and second surfaces in a main scanning direction, respectively, and first and second light guiding units configured to guide the first and second light fluxes from the first and second light sources to the first deflecting surface, respectively. An optical path of the first light flux in the first light guiding unit includes a straight line connecting the first light source and the first deflecting surface. An optical path of the second light flux in the second light guiding unit does not include a straight line connecting the second light source and the first deflecting surface.

Features of the disclosure will become apparent from the following description of embodiments with reference to the attached drawings. The following description of embodiments is described by way of example.

### BRIEF DESCRIPTION OF THE DRAWINGS

FIG. 1A is a partially developed view in a main scanning cross section of a light scanning apparatus according to a first embodiment of the present disclosure.

FIG. 1B is a partially developed view in a main scanning cross section of the light scanning apparatus according to the first embodiment.

FIG. 2 is a partial sub-scanning cross sectional view of the light scanning apparatus according to the first embodiment.

FIG. 3A is a partially enlarged perspective view of the light scanning apparatus according to the first embodiment.

FIG. 3B is a partially enlarged perspective view of a light scanning apparatus according to a modification of the first embodiment.

FIG. 4A is a partially enlarged perspective view of the light scanning apparatus according to the first embodiment.

FIG. 4B is a partially enlarged perspective view of a light scanning apparatus according to a comparative example.

FIG. 5A is a partially developed view in a main scanning cross section of a light scanning apparatus according to a second embodiment of the present disclosure.

FIG. 5B is a partially developed view in a main scanning cross section of the light scanning apparatus according to the second embodiment.

FIG. 6 is a partial sub-scanning cross sectional view of the light scanning apparatus according to the second embodiment.

FIG. 7 is a partially enlarged perspective view of the light scanning apparatus according to the second embodiment.

FIG. 8A is a partially developed view in a main scanning cross section of a light scanning apparatus according to a third embodiment of the present disclosure.

FIG. 8B is a partially developed view in a main scanning cross section of the light scanning apparatus according to the third embodiment.

FIG. 9 is a partial sub-scanning cross sectional view of the light scanning apparatus according to the third embodiment.

FIG. 10 is a partially enlarged perspective view of the light scanning apparatus according to the third embodiment.

FIG. 11 is a sub-scanning cross sectional view of a main part of a color image forming apparatus according to the present disclosure.

FIG. 12 is a partially enlarged perspective view of a light scanning apparatus disclosed in Japanese Patent Laid-Open No. 2023-083744.

### DESCRIPTION OF THE EMBODIMENTS

Hereinafter, a light scanning apparatus according to the present disclosure is described in detail with reference to the accompanying drawings. Note that the drawings described below may be drawn on a scale different from the actual scale in order to facilitate understanding of the present disclosure.

In the following description, a main scanning direction is a direction perpendicular to a rotation axis 55 of a deflecting unit 5 and optical axes of first to fourth imaging optical systems (a direction in which first to fourth light fluxes are deflected by the deflecting unit 5), and a sub-scanning direction is a direction parallel to the rotation axis 55 of the deflecting unit 5.

Further, a main scanning cross section is a cross section perpendicular to the sub-scanning direction, and a sub-scanning cross section is a cross section perpendicular to the main scanning direction.

Furthermore, a direction parallel to the optical axes of the first to fourth imaging optical systems, the main scanning direction, and the sub-scanning direction are defined as an X direction, a Y direction, and a Z direction, respectively.

### First Embodiment

Conventionally, a light scanning apparatus is used as an exposing apparatus mounted on an image forming apparatus such as a laser beam printer using an electrophotographic process.

Specifically, in the light scanning apparatus, a light flux modulated and emitted from a light source means according to an image signal from a personal computer side is guided to a deflecting unit such as a polygon mirror (rotary polygon mirror) by an incident optical system, and is then deflected by a deflecting surface of the deflecting unit.

Then, the deflected light flux is condensed in a spot shape on a photosensitive surface of a photosensitive drum as a surface to be scanned by an imaging optical system, and the condensed light flux scans the photosensitive surface to perform exposure recording of image information.

In addition, various color image forming apparatuses for forming a color image by scanning the photosensitive surfaces of a plurality of photosensitive drums using the light scanning apparatus have been proposed.

FIG. 12 shows a partially enlarged schematic perspective view of a light scanning apparatus 500 used in a color image forming apparatus disclosed in Japanese Patent Laid-Open No. 2023-083744.

As shown in FIG. 12, a plurality of light fluxes emitted from a plurality of semiconductor laser elements 10Y, 10M, 10C and 10K are condensed by a plurality of collimator lenses including collimator lenses 20Y and 20K, respectively, and then guided to a deflecting unit in the light scanning apparatus 500.

Each of the plurality of light fluxes deflected by the deflecting unit is guided onto a photosensitive surface of a photosensitive drum as a corresponding surface to be scanned by a corresponding imaging optical system to scan the corresponding photosensitive surface.

Japanese Patent Laid-Open No. 2023-083744 discloses a technique for obtaining a predetermined optical performance by finely adjusting relative positions between the plurality of semiconductor laser elements and the plurality of collimator lenses in the light scanning apparatus 500.

On the other hand, the technique disclosed in Japanese Patent Laid-Open No. 2023-083744 has the following issues.

Specifically, in the technique disclosed in Japanese Patent Laid-Open No. 2023-083744, first, positions of the collimator lenses 20Y and 20K corresponding to the semiconductor laser elements 10Y and 10K are adjusted with grasping the collimator lenses 20Y and 20K by jigs.

Next, after the adjustment, the collimator lenses 20Y and 20K are fixed by photo-curable resins P applied to gaps between a seating surface Hf1 of a laser holder H11 and a seating surface of a laser holder H12, respectively, and a lens holder H2 is attached by screwing.

Thereafter, positions of the collimator lenses (not shown) corresponding to the semiconductor laser elements 10M and 10C are adjusted with grasping the collimator lenses by jigs.

Then, after the adjustment, the collimator lenses are fixed by photo-curable resins P applied to gaps between a seating surface Hf21 and a seating surface Hf22 of the lens holder H2, respectively.

As described above, in the technique disclosed in Japanese Patent Laid-Open No. 2023-083744, it is necessary to perform a plurality of processes including the position adjustment and fixation of the collimator lenses 20Y and 20K, the attachment of the lens holder H2, and the position adjustment and fixation of the remaining collimator lenses.

That is, tact time is increased by performing the plurality of processes, and it is necessary to provide a member such as the lens holder H2, resulting in an increase in cost.

Therefore, an object of the present disclosure is to provide a light scanning apparatus in which a plurality of light sources and a plurality of incident optical systems are provided such that an arrangement adjustment and an assembly can be easily performed when the light scanning apparatus is provided in a small space to achieve reduction in cost and reduction in size and weight.

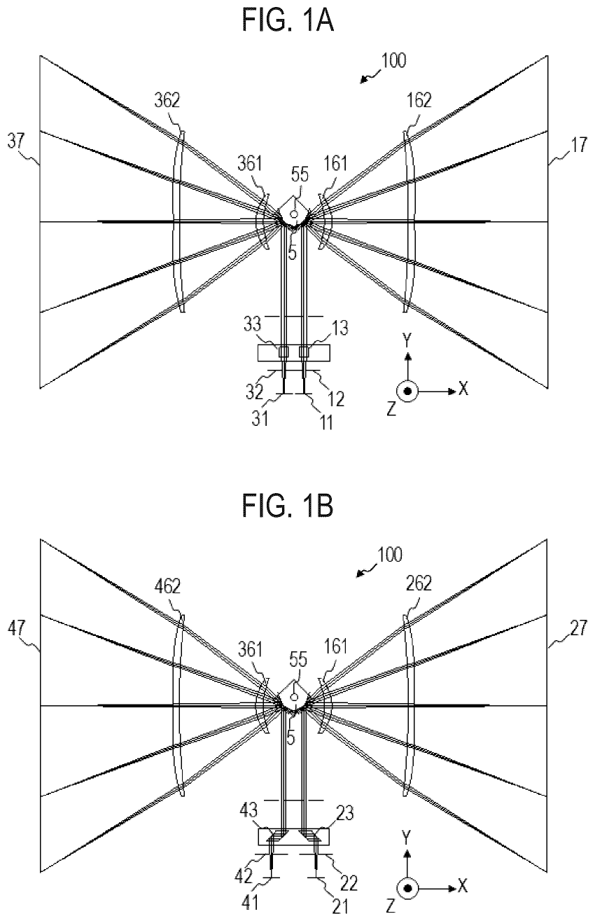

FIGS. 1A and 1B show partially schematic developed views in a main scanning cross section of a light scanning apparatus 100 according to a first embodiment of the present disclosure.

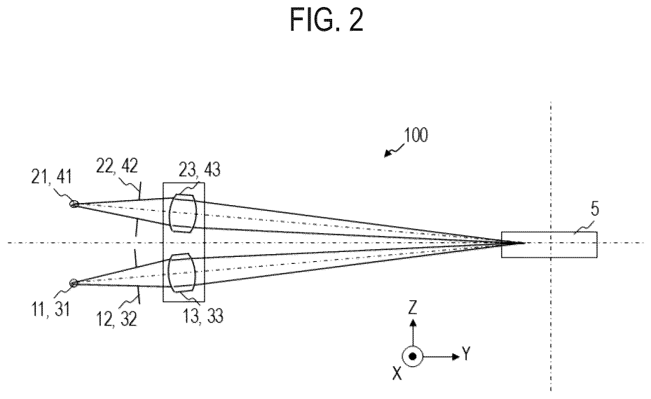

FIG. 2 shows a partial schematic sub-scanning cross sectional view of the light scanning apparatus 100 according to the first embodiment.

The light scanning apparatus 100 according to the present embodiment includes first, second, third and fourth light sources 11, 21, 31 and 41, and first, second, third and fourth stops 12, 22, 32 and 42.

Further, the light scanning apparatus 100 according to the present embodiment includes first, second, third and fourth incident optical elements 13, 23, 33 and 43 (first, second, third and fourth light guiding units), and a deflecting unit 5.

Furthermore, the light scanning apparatus 100 according to the present embodiment includes first scanning imaging elements 161 and 361, and second scanning imaging elements 162, 262, 362 and 462.

In the light scanning apparatus 100 according to the present embodiment, the first stop 12 and the first incident optical element 13 constitute a first incident optical system that guides a first light flux from the first light source 11 to the deflecting unit 5.

The second stop 22 and the second incident optical element 23 constitute a second incident optical system that guides a second light flux from the second light source 21 to the deflecting unit 5.

The third stop 32 and the third incident optical element 33 constitute a third incident optical system that guides a third light flux from the third light source 31 to the deflecting unit 5.

The fourth stop 42 and the fourth incident optical element 43 constitute a fourth incident optical system that guides a fourth light flux from the fourth light source 41 to the deflecting unit 5.

Further, in the light scanning apparatus 100 according to the present embodiment, the first scanning imaging element 161 and the second scanning imaging element 162 constitute a first imaging optical system (first optical system) that guides the first light flux deflected by the deflecting unit 5 to a first surface to be scanned 17.

The first scanning imaging element 161 and the second scanning imaging element 262 constitute a second imaging optical system (second optical system) that guides the second light flux deflected by the deflecting unit 5 to a second surface to be scanned 27.

The first scanning imaging element 361 and the second scanning imaging element 362 constitute a third imaging optical system (third optical system) that guides the third light flux deflected by the deflecting unit 5 to a third surface to be scanned 37.

The first scanning imaging element 361 and the second scanning imaging element 462 constitute a fourth imaging optical system (fourth optical system) that guides the fourth light flux deflected by the deflecting unit 5 to a fourth surface to be scanned 47.

As shown in FIGS. 1A and 1B, the first and second imaging optical systems, and the third and fourth imaging optical systems are arranged on sides opposite to each other with respect to the deflecting unit 5 in the main scanning cross section in the light scanning apparatus 100 according to the present embodiment.

The first and second light fluxes emitted from the first and second light sources 11 and 21 are guided to the first and second surfaces to be scanned 17 and 27 by the first and second incident optical systems and the first and second imaging optical systems provided on first and second optical paths, respectively.

The third and fourth light fluxes emitted from the third and fourth light sources 31 and 41 are guided to the third and fourth surfaces to be scanned 37 and 47 by the third and fourth incident optical systems and the third and fourth imaging optical systems provided on the third and fourth optical paths, respectively.

Further, as shown in FIG. 2, the light scanning apparatus 100 according to the present embodiment employs a so-called sub-scanning oblique incident system in which the first to fourth light fluxes emitted from the first to fourth light sources 11 to 41 are obliquely incident on the deflecting unit 5 by the first to fourth incident optical systems, respectively.

In other words, the first and second light fluxes from the first and second incident optical elements 13 and 23 are obliquely incident on a first deflecting surface 5a of the deflecting unit 5 in a sub-scanning cross section.

The third and fourth light fluxes from the third and fourth incident optical elements 33 and 43 are obliquely incident on a second deflecting surface 5b of the deflecting unit 5 in the sub-scanning cross section.

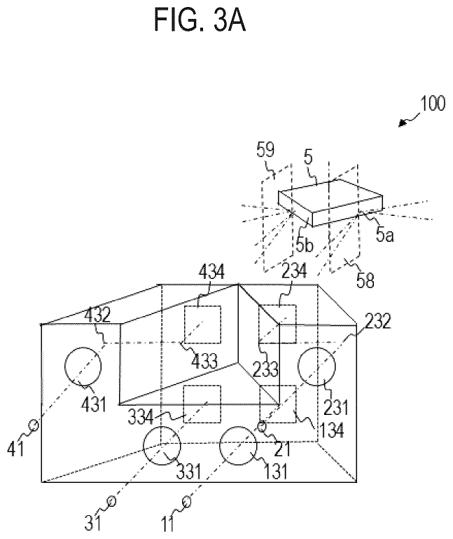

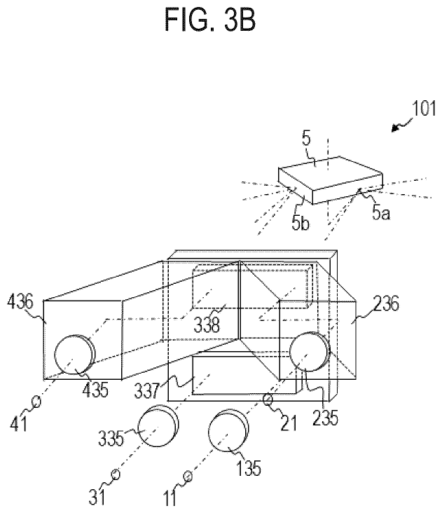

Then, the first and second light fluxes deflected by the first deflecting surface 5a (FIG. 3A) of the deflecting unit 5 are guided to the first and second surfaces to be scanned 17 and 27 by the first and second imaging optical systems.

The third and fourth light fluxes deflected by the second deflecting surface 5b (FIG. 3A) of the deflecting unit 5 are guided to the third and fourth surfaces to be scanned 37 and 47 by the third and fourth imaging optical systems.

Further, the first to fourth light fluxes deflected by the first deflecting surface 5a or the second deflecting surface 5b of the deflecting unit 5 are reflected by folding mirrors (not shown).

Furthermore, in the light scanning apparatus 100 according to the present embodiment, a part of the light flux deflected by the deflecting unit 5 is guided to a synchronization detection light receiving element (not shown) by a synchronization detection optical system (not shown).

Each of the first to fourth light sources 11 to 41 is formed of a semiconductor laser element, has at least one light emitting point, and is provided on a shared board (not shown).

The first to fourth stops 12 to 42 regulate light flux widths in both of the main scanning direction and the sub-scanning direction of the first to fourth light fluxes emitted from the first to fourth light sources 11 to 41, respectively.

In the light scanning apparatus 100 according to the present embodiment, main scanning stops that regulate the light flux widths in the main scanning direction of the first to fourth light fluxes and sub-scanning stops that regulate the light flux widths in the sub-scanning direction of the first to fourth light fluxes may be provided instead of the first to fourth stops 12 to 42.

In this case, it is possible to suppress an occurrence of jitter in the case of a monolithic multibeam in which each of the first to fourth light sources 11 to 41 has a plurality of light emitting points by arranging the main scanning stops in the vicinity of the deflecting unit 5.

The first to fourth incident optical elements 13 to 43 convert the first to fourth light fluxes that have passed through the first to fourth stops 12 to 42 into parallel light fluxes in the main scanning cross section, respectively, and condense the first to fourth light fluxes so as to convert them into convergent light fluxes in the sub-scanning cross section, respectively.

The parallel light flux includes not only a strictly parallel light flux but also a substantially parallel light flux such as a weakly divergent light flux or a weakly convergent light flux.

Specifically, the first to fourth incident optical elements 13 to 43 have powers different from each other between the main scanning direction and the sub-scanning direction, and have a function of coupling the first to fourth light fluxes from the first to fourth light sources 11 to 41, respectively.

Specific shapes of the first to fourth incident optical elements 13 to 43 are described later.

The deflecting unit 5 is a four-surfaces polygon mirror (rotary polygon mirror) that has four deflecting surfaces arranged on sides of a square in the main scanning cross section and rotates around a rotation axis 55.

In the light scanning apparatus 100 according to the present embodiment, the rotation axis 55 of the deflecting unit 5 is arranged at a position of a center of an inscribed circle inscribed in each of the four deflecting surfaces or a position of a center of a circumscribed circle passing through corners between adjacent deflecting surfaces.

Further, the deflecting unit 5 can be formed by, for example, cutting a metal block or forming a base material by resin molding using a mold to provide a vapor deposition film on each deflecting surface of the base material.

Each of the first scanning imaging elements 161 and 361 and the second scanning imaging elements 162 to 462 is a scanning lens of which an incident surface and an exit surface are formed by a predetermined free curved surface, and can be formed by molding an optical resin using a mold.

In the light scanning apparatus 100 according to the present embodiment, the first to fourth imaging optical systems have a constant speed characteristic of Y=Fθ to scan the first to fourth surfaces to be scanned 17 to 47 at a constant speed, respectively.

However, the present disclosure is not limited thereto, and each of the first to fourth imaging optical systems may have a non-constant speed characteristic such as Y=tan θ.

In the light scanning apparatus 100 according to the present embodiment, each of the first to fourth imaging optical systems is constituted by two scanning imaging elements, namely the first scanning imaging element 161 or 361 and the second scanning imaging element 162, 262, 362 or 462, but the present disclosure is not limited thereto.

That is, each of the first to fourth imaging optical systems may be constituted by a single scanning imaging element in order to reduce the cost, or may be constituted by three or more scanning imaging elements in order to further improve an optical performance.

In the light scanning apparatus 100 according to the present embodiment, the first to fourth imaging optical systems include the second scanning imaging elements 162 to 462, respectively.

On the other hand, the first scanning imaging element 161 is shared by the first and second imaging optical systems, and the first scanning imaging element 361 is shared by the third and fourth imaging optical systems.

The first to fourth light fluxes deflected by the deflecting unit 5 are condensed by the first to fourth imaging optical systems so as to form beam spots on the first to fourth surfaces to be scanned 17 to 47, respectively.

By rotating the deflecting unit 5, the formed beam spots scan a printed region from outermost off-axis image heights on sides where the first to fourth light sources 11 to 41 are arranged to outermost off-axis image heights on opposite sides on the first to fourth surfaces 17 to 47, respectively.

Next, specification values of the light scanning apparatus 100 according to the present embodiment are shown in the following Table 1.

Arrangements of the first incident optical system and the first imaging optical system are shown in the following Table 2, and arrangements of the second incident optical system and the second imaging optical system are shown in the following Table 3.

Shapes of exit surfaces 134 to 434 of the first to fourth incident optical elements 13 to 43 are shown in the following Table 4.

Shapes of the incident surfaces and the exit surfaces of the first scanning imaging elements 161 and 361, and the second scanning imaging elements 162 to 462 are shown in the following Table 5.

TABLE 1

| | |
|---|---|
| Wavelengths of first to fourth light fluxes (nm) | 790 |
| Angles α (°) between traveling directions of principal rays | 90 |
| of first to fourth light fluxes immediately before being | |
| incident on deflecting unit 5 and optical axes of first to fourth | |
| imaging optical systems | |
| Number N of deflecting surfaces in deflecting unit 5 | 4 |
| Diameter Φ of deflecting unit 5 (mm) | 20.0 |
| Width of deflecting surface in deflecting unit 5 (mm) | 14.142 |
| Distance between center of deflecting unit 5 and deflecting | 7.071 |
| surface (mm): | |
| X coordinate of rotation center of deflecting unit 5 (mm) | −5.400 |
| Y coordinate of rotation center of deflecting unit 5 (mm) | −4.600 |
| Fθ coefficient (mm/rad) | 142.28 |
| Y coordinate Ymax+ of outermost off-axis image height on | 107.0 |
| positive side (mm) | |
| Y coordinate Ymax− of outermost off-axis image height on | −107.0 |
| negative side (mm) | |
| Printed width Ymax+ − Ymax− (mm) | 214.0 |
| Maximum angle of view θmax+ (°) on positive side | 43.09 |
| Maximum angle of view θmax− (°) on negative side | −43.09 |
| Oblique incident angle β1 (°) formed by traveling direction | 3.0 |
| of principal ray of first light flux immediately before being | |
| incident on deflecting unit 5 with respect to main scanning | |
| cross section in sub-scanning cross section | |
| Oblique incident angle β2 (°) formed by traveling direction | −3.0 |
| of principal ray of second light flux immediately before | |
| being incident on deflecting unit 5 with respect to main | |
| scanning cross section in sub-scanning cross section | |
| Oblique incident angle β3 (°) formed by traveling direction | 3.0 |
| of principal ray of third light flux immediately before being | |
| incident on deflecting unit 5 with respect to main scanning | |
| cross section in sub-scanning cross section | |
| Oblique incident angle β4 (°) formed by traveling direction | −3.0 |
| of principal ray of fourth light flux immediately before being | |
| incident on deflecting unit 5 with respect to main scanning | |
| cross section in sub-scanning cross section | |
| Distance between first light source 11 and second light | 8.00 |
| source 21 in main scanning direction (mm) | |
| Distance between first light source 11 and third light | 8.00 |
| source 31 in main scanning direction (mm) | |
| Distance between first light source 11 and fourth light | 16.00 |
| source 41 in main scanning direction (mm) | |

TABLE 2

| | Surface | | | | | | | | |
|---|---|---|---|---|---|---|---|---|---|
| | number | R | N | x | y | z | gx(x) | gx(y) | gx(z) |
| Light emitting | 1 | 0.000 | 1.5105 | 0.000 | −113.844 | −5.966 | 0.000 | −0.999 | −0.052 |
| point of first light | | | | | | | | | |
| source 11 | | | | | | | | | |
| Exit surface of | 2 | 0.000 | 1.0000 | 0.000 | −113.594 | −5.953 | 0.000 | −0.999 | −0.052 |
| cover glass | | | | | | | | | |
| First stop 12 | 3 | 0.000 | 1.0000 | 0.000 | −98.065 | −5.139 | 0.000 | −0.999 | −0.052 |
| Incident surface | 4 | −12.616 | 1.5240 | 0.000 | −89.877 | −4.710 | 0.000 | −0.999 | −0.052 |
| 131 of first | | | | | | | | | |
| incident optical | | | | | | | | | |
| element 13 | | | | | | | | | |
| — | 5 | — | — | — | — | — | — | — | — |
| — | 6 | — | — | — | — | — | — | — | — |
| Exit surface 134 | 7 | Aspherical | 1.0000 | 0.000 | −82.886 | −4.344 | 0.000 | −0.999 | −0.052 |
| of first incident | | surface | | | | | | | |
| optical element 13 | | | | | | | | | |
| Deflecting unit 5 | 8 | 0.000 | 1.0000 | 1.118 | 1.859 | 0.000 | 0.922 | −0.388 | 0.000 |
| Incident surface of | 9 | Aspherical | 1.5240 | 13.500 | −0.373 | 0.000 | 1.000 | 0.000 | 0.000 |
| first scanning | | surface | | | | | | | |
| imaging element | | | | | | | | | |
| 161 | | | | | | | | | |
| Exit surface of | 10 | Aspherical | 1.0000 | 18.500 | −0.373 | 0.000 | 1.000 | 0.000 | 0.000 |
| first scanning | | surface | | | | | | | |
| imaging element | | | | | | | | | |
| 161 | | | | | | | | | |
| Incident surface of | 11 | Aspherical | 1.5240 | 69.000 | −0.373 | 2.055 | 1.000 | 0.000 | 0.000 |
| second scanning | | surface | | | | | | | |
| imaging element | | | | | | | | | |
| 162 | | | | | | | | | |
| Exit surface of | 12 | Aspherical | 1.0000 | 73.000 | −0.373 | 2.055 | 1.000 | 0.000 | 0.000 |
| second scanning | | surface | | | | | | | |
| imaging element | | | | | | | | | |
| 162 | | | | | | | | | |
| First surface to be | 13 | 0.000 | — | 161.000 | −0.373 | 0.000 | 1.000 | 0.000 | 0.000 |
| scanned 17 | | | | | | | | | |

Size of elliptical shape of first stop 12: 2.00 mm in main scanning direction × 1.24 mm in sub-scanning direction

TABLE 3

| | Surface | | | | | | | | |
|---|---|---|---|---|---|---|---|---|---|
| | number | R | N | x | y | z | gx(x) | gx(y) | gx(z) |
| Light emitting | 1 | 0.000 | 1.5105 | 8.000 | −113.844 | 5.966 | 0.000 | −0.999 | 0.052 |
| point of second | | | | | | | | | |
| light source 21 | | | | | | | | | |
| Exit surface of | 2 | 0.000 | 1.0000 | 8.000 | −113.594 | 5.953 | 0.000 | −0.999 | 0.052 |
| cover glass | | | | | | | | | |
| Second stop 22 | 3 | 0.000 | 1.0000 | 8.000 | −98.065 | 5.139 | 0.000 | −0.999 | 0.052 |
| Incident surface | 4 | −12.616 | 1.5240 | 8.000 | −89.877 | 4.710 | 0.000 | −0.999 | 0.052 |
| 231 of second | | | | | | | | | |
| incident optical | | | | | | | | | |
| element 23 | | | | | | | | | |
| First reflecting | 5 | 0.000 | 1.5240 | 8.000 | −86.381 | 4.527 | −0.707 | −0.706 | 0.037 |
| surface 232 of | | | | | | | | | |
| second incident | | | | | | | | | |
| optical element 23 | | | | | | | | | |
| Second reflecting | 6 | 0.000 | 1.5240 | 0.000 | −86.381 | 4.527 | 0.707 | 0.706 | −0.037 |
| surface 233 of | | | | | | | | | |
| second incident | | | | | | | | | |
| optical element 23 | | | | | | | | | |
| Exit surface 234 | 7 | Aspherical | 1.0000 | 0.000 | −82.886 | 4.344 | 0.000 | −0.999 | 0.052 |
| of second incident | | surface | | | | | | | |
| optical element 23 | | | | | | | | | |
| Deflecting unit 5 | 8 | 0.000 | 1.0000 | 1.118 | 1.859 | 0.000 | 0.922 | −0.388 | 0.000 |
| Incident surface of | 9 | Aspherical | 1.5240 | 13.500 | −0.373 | 0.000 | 1.000 | 0.000 | 0.000 |
| first scanning | | surface | | | | | | | |
| imaging element | | | | | | | | | |
| 161 | | | | | | | | | |
| Exit surface of | 10 | Aspherical | 1.0000 | 18.500 | −0.373 | 0.000 | 1.000 | 0.000 | 0.000 |
| first scanning | | surface | | | | | | | |
| imaging element | | | | | | | | | |
| 161 | | | | | | | | | |
| Incident surface of | 11 | Aspherical | 1.5240 | 69.000 | −0.373 | −2.055 | 1.000 | 0.000 | 0.000 |
| second scanning | | surface | | | | | | | |
| imaging element | | | | | | | | | |
| 262 | | | | | | | | | |
| Exit surface of | 12 | Aspherical | 1.0000 | 73.000 | −0.373 | −2.055 | 1.000 | 0.000 | 0.000 |
| second scanning | | surface | | | | | | | |
| imaging element | | | | | | | | | |
| 262 | | | | | | | | | |
| Second surface to | 13 | 0.000 | — | 161.000 | −0.373 | 0.000 | 1.000 | 0.000 | 0.000 |
| be scanned 27 | | | | | | | | | |

Size of elliptical shape of second stop 22: 2.00 mm in main scanning direction × 1.24 mm in sub-scanning direction

TABLE 4
Exit surfaces 134 to 434 of first to fourth incident optical elements 13 to 43

| Ryu | Kyu | B2u | B4u | B6u | B8u | B10u | B12u |
|---|---|---|---|---|---|---|---|
| 0.00E+00 | 0.00E+00 | 0.00E+00 | 0.00E+00 | 0.00E+00 | 0.00E+00 | 0.00E+00 | 0.00E+00 |
| Ryl | Kyl | B2l | B4l | B6l | B8l | B10l | B12l |
| 0.00E+00 | 0.00E+00 | 0.00E+00 | 0.00E+00 | 0.00E+00 | 0.00E+00 | 0.00E+00 | 0.00E+00 |

| B1 | B3 | B5 | B7 | B9 | B11 |
|---|---|---|---|---|---|
| 0.00E+00 | 0.00E+00 | 0.00E+00 | 0.00E+00 | 0.00E+00 | 0.00E+00 |

| rzu | E2u | E4u | E6u | E8u | E10u | E12u | E14u | E16u |
|---|---|---|---|---|---|---|---|---|
| 4.28E+01 | 0.00E+00 | 0.00E+00 | 0.00E+00 | 0.00E+00 | 0.00E+00 | 0.00E+00 | 0.00E+00 | 0.00E+00 |
| rzl | E2u | E4u | E6u | E8u | E10u | E12l | E14l | E16l |
| 4.28E+01 | 0.00E+00 | 0.00E+00 | 0.00E+00 | 0.00E+00 | 0.00E+00 | 0.00E+00 | 0.00E+00 | 0.00E+00 |

| E1 | E3 | E5 | E7 | E9 |
|---|---|---|---|---|
| 0.00E+00 | 0.00E+00 | 0.00E+00 | 0.00E+00 | 0.00E+00 |

| M0_1 | M1_1 | M2_1 | M3_1 | M4_1 | M5_1 | M6_1 | M7_1 |
|---|---|---|---|---|---|---|---|
| 0.00E+00 | 0.00E+00 | 0.00E+00 | 0.00E+00 | 0.00E+00 | 0.00E+00 | 0.00E+00 | 0.00E+00 |

TABLE 5
Incident surfaces of first scanning imaging elements 161 and 361

| Ryu | Kyu | B2u | B4u | B6u | B8u | B10u | B12u |
|---|---|---|---|---|---|---|---|
| −3.42E+01 | 1.95E+00 | 0.00E+00 | 1.65E−05 | 9.19E−08 | −4.21E−10 | 7.14E−13 | 0.00E+00 |
| Ryl | Kyl | B2l | B4l | B6l | B8l | B10l | B12l |
| −3.42E+01 | 1.95E+00 | 0.00E+00 | 1.65E−05 | 9.19E−08 | −4.21E−10 | 7.14E−13 | 0.00E+00 |

| B1 | B3 | B5 | B7 | B9 | B11 |
|---|---|---|---|---|---|
| 0.00E+00 | 0.00E+00 | 0.00E+00 | 0.00E+00 | 0.00E+00 | 0.00E+00 |

| rzu | E2u | E4u | E6u | E8u | E10u | E12u | E14u | E16u |
|---|---|---|---|---|---|---|---|---|
| −1.00E+03 | 0.00E+00 | 0.00E+00 | 0.00E+00 | 0.00E+00 | 0.00E+00 | 0.00E+00 | 0.00E+00 | 0.00E+00 |
| rzl | E2l | E4l | E6l | E8l | E10l | E12l | E14l | E16l |
| −1.00E+03 | 0.00E+00 | 0.00E+00 | 0.00E+00 | 0.00E+00 | 0.00E+00 | 0.00E+00 | 0.00E+00 | 0.00E+00 |

| E1 | E3 | E5 | E7 | E9 |
|---|---|---|---|---|
| 0.00E+00 | 0.00E+00 | 0.00E+00 | 0.00E+00 | 0.00E+00 |

| M0_1 | M1_1 | M2_1 | M3_1 | M4_1 | M5_1 | M6_1 | M7_1 |
|---|---|---|---|---|---|---|---|
| 0.00E+00 | 0.00E+00 | 0.00E+00 | 0.00E+00 | 0.00E+00 | 0.00E+00 | 0.00E+00 | 0.00E+00 |

Exit surfaces of first scanning imaging elements 161 and 361

| Ryu | Kyu | B2u | B4u | B6u | B8u | B10u | B12u |
|---|---|---|---|---|---|---|---|
| −2.36E+01 | −2.98E+00 | 0.00E+00 | −1.97E−05 | 7.87E−08 | −1.47E−10 | 3.00E−14 | 0.00E+00 |
| Ryl | Kyl | B2l | B4l | B6l | B8l | B10l | B12l |
| −2.36E+01 | −2.98E+00 | 0.00E+00 | −1.94E−05 | 7.58E−08 | −1.35E−10 | 1.15E−14 | 0.00E+00 |

| B1 | B3 | B5 | B7 | B9 | B11 |
|---|---|---|---|---|---|
| 0.00E+00 | 0.00E+00 | 0.00E+00 | 0.00E+00 | 0.00E+00 | 0.00E+00 |

| rzu | E2u | E4u | E6u | E8u | E10u | E12u | E14u | E16u |
|---|---|---|---|---|---|---|---|---|
| −1.00E+03 | 0.00E+00 | 0.00E+00 | 0.00E+00 | 0.00E+00 | 0.00E+00 | 0.00E+00 | 0.00E+00 | 0.00E+00 |
| rzl | E2l | E4l | E6l | E8l | E10l | E12l | E14l | E16l |
| −1.00E+03 | 0.00E+00 | 0.00E+00 | 0.00E+00 | 0.00E+00 | 0.00E+00 | 0.00E+00 | 0.00E+00 | 0.00E+00 |

| E1 | E3 | E5 | E7 | E9 |
|---|---|---|---|---|
| 0.00E+00 | 0.00E+00 | 0.00E+00 | 0.00E+00 | 0.00E+00 |

| M0_1 | M1_1 | M2_1 | M3_1 | M4_1 | M5_1 | M6_1 | M7_1 |
|---|---|---|---|---|---|---|---|
| 0.00E+00 | 0.00E+00 | 0.00E+00 | 0.00E+00 | 0.00E+00 | 0.00E+00 | 0.00E+00 | 0.00E+00 |

Incident surfaces of second scanning imaging element 162 to 462

| Ryu | Kyu | B2u | B4u | B6u | B8u | B10u | B12u |
|---|---|---|---|---|---|---|---|
| −5.24E+02 | 0.00E+00 | 0.00E+00 | 0.00E+00 | 0.00E+00 | 0.00E+00 | 0.00E+00 | 0.00E+00 |
| Ryl | Kyl | B2l | B4l | B6l | B8l | B10l | B12l |
| −5.24E+02 | 0.00E+00 | 0.00E+00 | 0.00E+00 | 0.00E+00 | 0.00E+00 | 0.00E+00 | 0.00E+00 |

| B1 | B3 | B5 | B7 | B9 | B11 |
|---|---|---|---|---|---|
| 0.00E+00 | 0.00E+00 | 0.00E+00 | 0.00E+00 | 0.00E+00 | 0.00E+00 |

| rzu | E2u | E4u | E6u | E8u | E10u | E12u | E14u | E16u |
|---|---|---|---|---|---|---|---|---|
| 5.50E+01 | 4.14E−04 | −2.58E−08 | −1.66E−11 | 1.77E−15 | 0.00E+00 | 0.00E+00 | 0.00E+00 | 0.00E+00 |

| rzl | E2l | E4l | E6l | E8l | E10l | E12l | E14l | E16l |
|---|---|---|---|---|---|---|---|---|
| 5.50E+01 | 4.42E−04 | 2.01E−08 | −8.73E−12 | −2.38E−15 | 0.00E+00 | 0.00E+00 | 0.00E+00 | 0.00E+00 |

| E1 | E3 | E5 | E7 | E9 |
|---|---|---|---|---|
| 0.00E+00 | 0.00E+00 | 0.00E+00 | 0.00E+00 | 0.00E+00 |

| M0_1 | M1_1 | M2_1 | M3_1 | M4_1 | M5_1 | M6_1 | M7_1 |
|---|---|---|---|---|---|---|---|
| 0.00E+00 | 0.00E+00 | 0.00E+00 | 0.00E+00 | 0.00E+00 | 0.00E+00 | 0.00E+00 | 0.00E+00 |

Exit surfaces of second scanning imaging element 162 to 462

| Ryu | Kyu | B2u | B4u | B6u | B8u | B10u | B12u |
|---|---|---|---|---|---|---|---|
| 8.64E+02 | 1.78E+02 | 0.00E+00 | −9.79E−07 | 1.42E−10 | −1.23E−14 | −5.63E−19 | 0.00E+00 |
| Ryl | Kyl | B2l | B4l | B6l | B8l | B10l | B12l |
| 8.64E+02 | 1.78E+02 | 0.00E+00 | −9.79E−07 | 1.42E−10 | −1.23E−14 | −5.63E−19 | 0.00E+00 |

| B1 | B3 | B5 | B7 | B9 | B11 |
|---|---|---|---|---|---|
| 0.00E+00 | 0.00E+00 | 0.00E+00 | 0.00E+00 | 0.00E+00 | 0.00E+00 |

| rzu | E2u | E4u | E6u | E8u | E10u | E12u | E14u | E16u |
|---|---|---|---|---|---|---|---|---|
| −3.21E+01 | 2.97E−05 | 9.42E−10 | 8.06E−13 | 2.66E−16 | 0.00E+00 | 0.00E+00 | 0.00E+00 | 0.00E+00 |

| rzl | E2l | E4l | E6l | E8l | E10l | E12l | E14l | E16l |
|---|---|---|---|---|---|---|---|---|
| −3.21E+01 | 1.02E−05 | −3.71E−09 | 1.45E−12 | 2.35E−16 | 0.00E+00 | 0.00E+00 | 0.00E+00 | 0.00E+00 |

| E1 | E3 | E5 | E7 | E9 |
|---|---|---|---|---|
| 0.00E+00 | 0.00E+00 | 0.00E+00 | 0.00E+00 | 0.00E+00 |

| M0_1 | M1_1 | M2_1 | M3_1 | M4_1 | M5_1 | M6_1 | M7_1 |
|---|---|---|---|---|---|---|---|
| 0.00E+00 | 0.00E+00 | 0.00E+00 | 0.00E+00 | 0.00E+00 | 0.00E+00 | 0.00E+00 | 0.00E+00 |

In Tables 4 and 5, “E−X” means 10^{-X}.

Regarding arrangements of the third incident optical system and the third imaging optical system provided in the light scanning apparatus 100 according to the present embodiment, the values shown in Table 2 may be converted so as to be symmetrical with respect to a plane including the rotation axis 55 of the deflecting unit 5 and parallel to the Y direction and the Z direction.

Similarly, regarding arrangements of the fourth incident optical system and the fourth imaging optical system provided in the light scanning apparatus 100 according to the present embodiment, the values shown in Table 3 may be converted so as to be symmetrical with respect to the plane that includes the rotation axis 55 of the deflecting unit 5 and is parallel to the Y direction and the Z direction.

A shape (meridional line shape) in the main scanning cross section of each of the exit surfaces 134 to 434 of the first to fourth incident optical elements 13 to 43 provided in the light scanning apparatus 100 according to the present embodiment is expressed by the following Expression (1).

Further, a shape in the main scanning cross section of each of the incident surfaces and the exit surfaces of the first scanning imaging elements 161 and 361, and the incident surfaces and the exit surfaces of the second scanning imaging elements 162 to 462 provided in the light scanning apparatus 100 according to the present embodiment is also expressed by the following Expression (1):

$$X = \frac{\frac{{Y}^{2}}{{R}_{Y}}}{1 + \sqrt{1 - ( 1 + {K}_{Y} ) {( \frac{Y}{{R}_{Y}} )}^{2}}} + {\sum }_{i = 1}^{12} {B}_{i} {Y}^{i} . \qquad ( 1 )$$

In Expression (1), R_{y} represents a curvature radius, K_{Y} represents an eccentricity, and Bᵢ (i=1, 2, 3, 4, 5, 6, 7, 8, 9, 10, 11 and 12) represent aspherical coefficients.

Further, in Expression (1), a subscript u is added to the aspherical coefficients Bᵢ on a positive side (namely, Bᵢᵤ), and a subscript l is added to the aspherical coefficients Bᵢ on a negative side (namely, Bᵢₗ) as shown in Tables 4 and 5, when the aspherical coefficients Bᵢ on the positive side and the negative side with respect to Y are different from each other.

The same applies to coefficients Mⱼₖ in Expression (2) and coefficients Eⱼ in Expression (3) shown below.

A shape (sagittal line shape) in the sub-scanning cross section of each of the exit surfaces 134 to 434 of the first to fourth incident optical elements 13 to 43 provided in the light scanning apparatus 100 according to the present embodiment is expressed by the following Expression (2).

Further, a shape in the sub-scanning cross section of each of the incident surfaces and the exit surfaces of the first scanning imaging elements 161 and 361, and the incident surfaces and the exit surfaces of the second scanning imaging elements 162 to 462 provided in the light scanning apparatus 100 according to the present embodiment is also expressed by the following Expression (2):

$$S = \frac{\frac{{Z}^{2}}{{r}_{Z}^{′}}}{1 + \sqrt{1 - {( \frac{Z}{{r}_{Z}^{′}} )}^{2}}} + {\sum }_{j = 0}^{7} {\sum }_{k = 1}^{1} {M}_{jk} {Y}^{j} {Z}^{k} . \qquad ( 2 )$$

In Expression (2), S represents a surface shape in a cross section which includes a surface normal on a meridional line at each position in the main scanning direction and is perpendicular to the main scanning cross section, and Mⱼₖ (j=0, 1, 2, 3, 4, 5, 6 and 7, k=1) represent aspherical coefficients.

Further, r_{z}′ shown in Expression (2) represents a curvature radius (curvature radius of sagittal line) in the sub-scanning cross section at a position away from the optical axis by Y in the main scanning direction, and continuously changes in accordance with a magnitude of Y as expressed by the following Expression (3):

$${r}_{Z}^{′} = {r}_{Z} ( 1 + {\sum }_{j = 1}^{16} {E}_{j} {Y}^{j} ) . \qquad ( 3 )$$

In Expression (3), r_{z} represents the curvature radius of sagittal line on the optical axis, and Eⱼ (j=1, 2, 3, 4, 5, 6, 7, 8, 9, 10, 12, 14, and 16) represent aspherical coefficients (sagittal line changing coefficients).

Next, characteristic structures of the light scanning apparatus 100 according to the present embodiment are described.

FIG. 3A shows a partially enlarged schematic perspective view of the light scanning apparatus 100 according to the present embodiment.

As shown in FIG. 3A, the first to fourth incident optical elements 13 to 43 are integrally formed as a compound-eyed optical element in the light scanning apparatus 100 according to the present embodiment.

Further, each of incident surfaces 131, 231, 331 and 431 of the first to fourth incident optical elements 13 to 43 has a spherical shape that is rotationally symmetrical with respect to the optical axis.

Thereby, the first to fourth light fluxes incident on the incident surfaces 131 to 431 of the first to fourth incident optical elements 13 to 43 are converted into parallel light fluxes in both of the main scanning cross section and the sub-scanning cross section.

However, the present disclosure is not limited thereto, and each of the incident surfaces 131 to 431 of the first to fourth incident optical elements 13 to 43 may have an aspherical shape.

Each of the exit surfaces 134, 234, 334 and 434 of the first to fourth incident optical elements 13 to 43 is an anamorphic surface having power in the sub-scanning cross section, namely has a cylinder shape.

The exit surfaces 134 to 434 of the first to fourth incident optical elements 13 to 43 converge the parallel light fluxes from the incident surfaces 131 to 431 in the sub-scanning cross section, respectively.

In this manner, the first to fourth light fluxes are converged in the sub-scanning cross section by the exit surfaces 134 to 434, respectively, to form line images in the vicinities of first and second deflecting surfaces 5a and 5b of the deflecting unit 5.

As shown in FIG. 3A, the second incident optical element 23 has first and second reflecting surfaces 232 and 233 (first and second reflecting surfaces), and the fourth incident optical element 43 has first and second reflecting surfaces 432 and 433 (third and fourth reflecting surfaces).

That is, the first light flux entering from the incident surface 131 (first optical surface, first incident surface) exits from the exit surface 134 (second optical surface, first exit surface) in the first incident optical element 13.

On the other hand, the second light flux entering from the incident surface 231 (third optical surface, second incident surface) is reflected by each of the first and second reflecting surfaces 232 and 233, and then exits from the exit surface 234 (fourth optical surface, second exit surface) in the second incident optical element 23.

Further, the third light flux entering from the incident surface 331 (fifth optical surface, third incident surface) exits from the exit surface 334 (sixth optical surface, third exit surface) in the third incident optical element 33.

On the other hand, the fourth light flux entering from the incident surface 431 (seventh optical surface, fourth incident surface) is reflected by each of the first and second reflecting surfaces 432 and 433, and then exits from the exit surface 434 (eighth optical surface, fourth exit surface) in the fourth incident optical element 43.

That is, optical paths of the first and third light fluxes in the first and third incident optical elements 13 and 33 are straight in the light scanning apparatus 100 according to the present embodiment.

In other words, the optical paths of the first and third light fluxes between the first and third light sources 11 and 31 and the first and second deflecting surfaces 5a and 5b of the deflecting unit 5 are straight in the light scanning apparatus 100 according to the present embodiment.

In still other words, the optical paths of the first and third light fluxes in the first and third incident optical elements 13 and 33 include straight lines connecting the first and third light sources 11 and 31 and the first and second deflecting surfaces 5a and 5b of the deflecting unit 5, respectively.

On the other hand, optical paths of the second and fourth light fluxes in the second and fourth incident optical elements 23 and 43 are not straight in the light scanning apparatus 100 according to the present embodiment.

In other words, the optical paths of the second and fourth light fluxes between the second and fourth light sources 21 and 41 and the first and second deflecting surfaces 5a and 5b of the deflecting unit 5 are not straight in the light scanning apparatus 100 according to the present embodiment.

In still other words, the optical paths of the second and fourth light fluxes in the second and fourth incident optical elements 23 and 43 do not include straight lines connecting the second and fourth light sources 21 and 41 and the first and second deflecting surfaces 5a and 5b of the deflecting unit 5, respectively.

In one embodiment, each of the first and second reflecting surfaces 232 and 233 provided in the second incident optical element 23 and the first and second reflecting surfaces 432 and 433 provided in the fourth incident optical element 43 is to be a total reflecting surface.

In addition, the number of reflecting surfaces formed in each of the second and fourth incident optical elements 23 and 43 provided in the light scanning apparatus 100 according to the present embodiment is not limited to the above.

In the light scanning apparatus 100 according to the present embodiment, oblique incident angles formed by traveling directions of the first and third light fluxes emitted from the first and third light sources 11 and 31 with respect to the main scanning cross section in the sub-scanning cross section are the same as each other.

Further, oblique incidence angles formed by traveling directions of the second and fourth light fluxes emitted from the second and fourth light sources 21 and 41 with respect to the main scanning cross section in the sub-scanning cross section are the same as each other.

On the other hand, the oblique incidence angles of the first and third light fluxes are different from those of the second and fourth light fluxes.

Each of the first to fourth incident optical elements 13 to 43 is formed by molding a resin material using a mold in order to achieve cost reduction and ease of manufacturing.

In this case, condensed degrees of the first to fourth light fluxes by the first to fourth incident optical elements 13 to 43 may vary according to an environmental temperature since a refractive index of the resin material varies according to the environmental temperature.

Therefore, a temperature compensation optical system may be employed by forming diffraction gratings on the incident surfaces 131 to 431 or the exit surfaces 134 to 434.

Further, a diffraction grating may be formed on the first reflecting surfaces 232 and 432 or the second reflecting surfaces 233 and 433 to employ a temperature compensation optical system in the second and fourth incident optical elements 23 and 43, respectively.

As shown in FIG. 3A, principal rays of the first and second light fluxes immediately before being incident on the first deflecting surface 5a of the deflecting unit 5 are in a predetermined plane 58 parallel to the sub-scanning direction in the light scanning apparatus 100 according to the present embodiment.

In other words, the first and second light fluxes emitted from the first and second light sources 11 and 21 are incident on the first deflecting surface 5a of the deflecting unit 5 by the first and second incident optical systems in the light scanning apparatus 100 according to the present embodiment.

Further, principal rays of the third and fourth light fluxes immediately before being incident on the second deflecting surface 5b of the deflecting unit 5 are in a predetermined plane 59 parallel to the sub-scanning direction.

In other words, the third and fourth light fluxes emitted from the third and fourth light sources 31 and 41 are incident on the second deflecting surface 5b of the deflecting unit 5 by the third and fourth incident optical systems in the light scanning apparatus 100 according to the present embodiment.

As shown in FIG. 3A, a straight line (first straight line) passing through centers (first and second centers) of light emitting surfaces of the first and second light sources 11 and 21 is skewed with respect to the rotation axis 55 of the deflecting unit 5, and is not parallel to the sub-scanning direction.

Further, a straight line (second straight line) passing through centers (third and fourth centers) of light emitting surfaces of the third and fourth light sources 31 and 41 is also skewed with respect to the rotation axis 55 of the deflecting unit 5, and is not parallel to the sub-scanning direction.

Here, a center of a light emitting surface of a light source is defined as a position of a light emitting point when the light source has the single light emitting point, and is defined as a middle point between two light emitting points arranged at both ends when the light source has a plurality of light emitting points arrayed on a predetermined straight line.

The centers of the light emitting surfaces of the first to fourth light sources 11 to 41 are arranged on corners of a predetermined trapezoid in a predetermined plane.

In other words, signs of angles formed with respect to the sub-scanning direction by the straight line passing through the centers of the light emitting surfaces of the first and second light sources 11 and 21 and the straight line passing through the centers of the light emitting surfaces of the third and fourth light sources 31 and 41 are different from each other.

Since the centers of the light emitting surfaces of the first to fourth light sources 11 to 41 are arranged on the predetermined plane, the first to fourth light sources 11 to 41 are driven to emit light by a shared light emitting board (not shown).

Specifically, in the light scanning apparatus 100 according to one embodiment, an absolute value |φ₁| (°) of an angle (first angle) between a straight line passing through the centers of the light emitting surfaces of the first and second light sources 11 and 21 and a straight line parallel to the sub-scanning direction satisfies the following Inequality (4).

Further, in one embodiment, an absolute value |φ₂| (°) of an angle (second angle) between a straight line passing through the centers of the light emitting surfaces of the third and fourth light sources 31 and 41 and a straight line parallel to the sub-scanning direction satisfies the following Inequality (5):

$$30. \leq \vert {ϕ}_{1} \vert \leq 60. \qquad ( 4 )$$

$$30. \leq \vert {ϕ}_{2} \vert \leq 60. . \qquad ( 5 )$$

In the light scanning apparatus 100 according to the embodiment, the following Inequalities (4a) and (5a) are satisfied instead of Inequalities (4) and (5):

$$33. \leq \vert {ϕ}_{1} \vert \leq 56. \qquad ( 4 a )$$

$$33. \leq \vert {ϕ}_{2} \vert \leq 56. . \qquad ( 5 a )$$

Specifically, the Inequalities (4), (4a), (5) and (5a) are satisfied since |φ₁|=|φ₂/=33.8 in the light scanning apparatus 100 according to the present embodiment.

As shown in FIGS. 1A and 1B, optical path lengths from the centers of the light emitting surfaces of the first to fourth light sources 11 to 41 to the incident surfaces 131 to 431 of the first to fourth incident optical elements 13 to 43 are the same as each other in the light scanning apparatus 100 according to the present embodiment.

Further, optical path lengths from the exit surfaces 134 and 234 of the first and second incident optical elements 13 and 23 to an on-axis deflection point on the first deflecting surface 5a and those from the exit surfaces 334 and 434 of the third and fourth incident optical elements 33 and 43 to an on-axis deflection point on the second deflecting surface 5b are all equal.

Furthermore, optical path lengths in the first and third incident optical elements 13 and 33 are the same as each other, and optical path lengths in the second and fourth incident optical elements 23 and 43 are the same as each other.

On the other hand, the optical path lengths in the first and third incident optical elements 13 and 33 are different from those in the second and fourth incident optical elements 23 and 43, and specifically, the latter is larger than the former.

Therefore, the optical path lengths from the centers of the light emitting surfaces of the first and third light sources 11 and 31 to the on-axis deflection points on the first and second deflecting surfaces 5a and 5b of the deflecting unit 5 are the same as each other.

Further, the optical path lengths from the centers of the light emitting surfaces of the second and fourth light sources 21 and 41 to the on-axis deflection points on the first and second deflecting surfaces 5a and 5b of the deflecting unit 5 are the same as each other.

On the other hand, the optical path lengths from the centers of the light emitting surfaces of the first and second light sources 11 and 21 to the on-axis deflection point (first on-axis deflection point) on the first deflecting surface 5a of the deflecting unit 5 are different from each other.

Further, the optical path lengths from the centers of the light emitting surfaces of the third and fourth light sources 31 and 41 to the on-axis deflection point (second on-axis deflection point) on the second deflecting surface 5b of the deflecting unit 5 are different from each other.

In the light scanning apparatus 100 according to the present embodiment, the first to fourth light fluxes are converted into parallel light fluxes between the incident surfaces 131 to 431 and the exit surfaces 134 to 434 of the first to fourth incident optical elements 13 to 43, respectively.

Therefore, it is possible to make an arrangement and magnification of optical surfaces in the first to fourth incident optical systems coincide with each other by making shapes of the incident surfaces 131 to 431 the same as each other and making shapes of the exit surfaces 134 to 434 the same as each other.

On the other hand, if it is difficult to convert the first to fourth light fluxes into parallel light fluxes between the incident surfaces 131 to 431 and the exit surfaces 134 to 434 of the first to fourth incident optical elements 13 to 43, respectively, the following operation may be performed.

That is, the first reflecting surfaces 232 and 432 and the second reflecting surfaces 233 and 433 may be formed so as to have powers in the second and fourth incident optical elements 23 and 43.

Thereby, the shapes of the incident surfaces 131 to 431 can be made the same as each other, and the shapes of the exit surfaces 134 to 434 can be made the same as each other in the first to fourth incident optical elements 13 to 43.

Therefore, the arrangement and the magnification of optical surfaces in the first to fourth incident optical systems can coincide with each other.

However, in this case, it is necessary to pay attention to a tolerance since the number of optical surfaces with power increases.

As described above, in one embodiment, the first to fourth light fluxes is converted into the parallel light fluxes between the incident surfaces 131 to 431 and the exit surfaces 134 to 434 of the first to fourth incident optical elements 13 to 43 in the light scanning apparatus 100 according to the embodiment.

Therefore, each of the incident surfaces 131 to 431 of the first to fourth incident optical elements 13 to 43 has a rotationally symmetrical shape with respect to the optical axis.

In other words, in one embodiment, each of the incident surfaces 131 to 431 of the first to fourth incident optical elements 13 to 43 are formed as a refractive surface or a diffractive surface that is rotationally symmetrical with respect to the optical axis.

When a rotationally symmetrical coupling lens is used in a conventional light scanning apparatus, an incident surface thereof is generally formed as a flat surface or a gentle spherical surface, and an exit surface thereof is generally formed a spherical surface having power, in order to suppress an occurrence of spherical aberration.

On the other hand, each of the incident surfaces 131 to 431 of the first to fourth incident optical elements 13 to 43 provided in the light scanning apparatus 100 according to the present embodiment has a spherical shape that is rotationally symmetrical with respect to the optical axis as described above.

Therefore, it should be noted that a spherical aberration occurs in the first to fourth incident optical elements 13 to 43 provided in the light scanning apparatus 100 according to the present embodiment.

In order to suppress the occurrence of spherical aberration in the first to fourth incident optical elements 13 to 43 provided in the light scanning apparatus 100 according to the present embodiment, each of the incident surfaces 131 to 431 may be formed to have an aspherical shape that is rotationally symmetrical with respect to the optical axis.

Alternatively, the occurrence of spherical aberration may be suppressed by forming each of the exit surfaces 134 to 434 such that a high-order aspherical amount is added to the anamorphic surface.

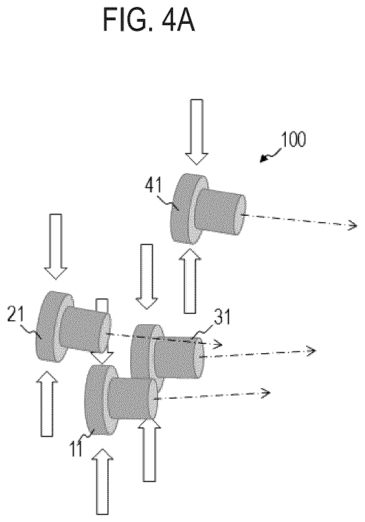

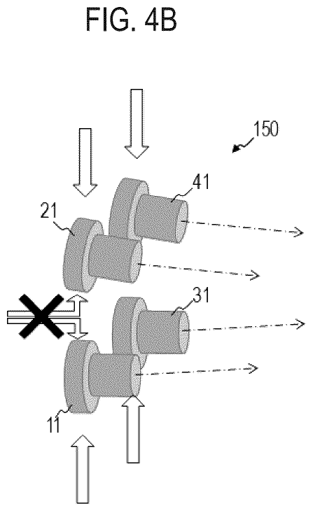

FIGS. 4A and 4B show partially enlarged schematic perspective views of the light scanning apparatus 100 according to the present embodiment and a light scanning apparatus 150 according to a comparative example, respectively.

The light scanning apparatus 150 according to the comparative example has the same configuration as that of the light scanning apparatus 100 according to the present embodiment except that an arrangement of optical elements is different, so that the same members are denoted by the same reference numerals, and the description thereof is omitted.

Specifically, in the light scanning apparatus 150 according to the comparative example, the first and second light sources 11 and 21 are arranged at the same position in the main scanning cross section, and the third and fourth light sources 31 and 41 are also arranged at the same position in the main scanning cross section, as shown in FIG. 4B.

Therefore, the first and second incident optical elements 13 and 23 are arranged at the same positions in the main scanning cross section, and the third and fourth incident optical elements 33 and 43 are also arranged at the same positions in the main scanning cross section in the light scanning apparatus 150 according to the comparative example.

Accordingly, as indicated by arrows in FIG. 4B, it is difficult to secure a sufficient space for arranging jigs when positions of the first to fourth light sources 11 to 41 are adjusted by grasping them with the jigs from above and below in the sub-scanning direction in the light scanning apparatus 150 according to the comparative example.

That is, it is not simple to adjust a relative positional relationship between the first to fourth light sources 11 to 41 and the first to fourth incident optical elements 13 to 43 in the light scanning apparatus 150 according to the comparative example.

On the other hand, when the first and second light sources 11 and 21 are largely separated from each other and the third and fourth light sources 31 and 41 are largely separated from each other in the sub-scanning direction in order to secure the sufficient space, a height increases, in the light scanning apparatus 150 according to the comparative example.

Therefore, in the light scanning apparatus 100 according to the present embodiment, the first and second light sources 11 and 21 are arranged at positions different from each other in the main scanning cross section, and the third and fourth light sources 31 and 41 are also arranged at positions different from each other in the main scanning cross section, as shown in FIGS. 3A and 4A.

Thereby, arrangements of the first to fourth light sources 11 to 41 and the first to fourth incident optical systems are optimized.

That is, each of the first to fourth light sources 11 to 41 can be easily grasped by jigs from above and below in the sub-scanning direction as indicated by arrows in FIG. 4A.

Thereby, relative positions between the first to fourth light sources 11 to 41 and the first to fourth incident optical elements 13 to 43 can be simply adjusted.

In addition, since all positions of the first to fourth light sources 11 to 41 can be simultaneously adjusted by grasping them using the jigs, it is possible to reduce time for assembling and adjusting the light scanning apparatus 100 according to the present embodiment.

Further, the number of components for assembling and adjusting the light scanning apparatus 100 according to the present embodiment can be reduced, and the number of man-hours for the assembly and adjustment can also be reduced.

Furthermore, in the light scanning apparatus 100 according to one embodiment, structures are not provided on upper and lower sides in the sub-scanning direction of each of the first to fourth light sources 11 to 41 such that the jigs can directly access them since each optical element is accommodated and fixed in an optical housing.

In another embodiment, the optical elements are fixed to the optical housing by adhering them in order to reduce the cost after relative positions of the first to fourth light sources 11 to 41 with respect to the first to fourth incident optical elements 13 to 43 are adjusted with grasping the first to fourth light sources 11 to 41 by the jigs.

In the light scanning apparatus 100 according to the present embodiment, a holding member for holding each of the first to fourth light sources 11 to 41 may be provided to grasp the holding member by the jig instead of grasping the first to fourth light sources 11 to 41 with the jigs.

Absolute values of angles in the main scanning cross section between traveling directions of principal rays of the first and second light fluxes immediately before being incident on the first deflecting surface 5a of the deflecting unit 5 and optical axes of the first and second imaging optical systems are represented by |α₁| (°) and |α₂|) (°, respectively.

Further, absolute values of angles in the main scanning cross section between traveling directions of principal rays of the third and fourth light fluxes immediately before being incident on the second deflecting surface 5b of the deflecting unit 5 and optical axes of the third and fourth imaging optical systems are represented by |α₃| (°) and |α₄| (°), respectively.

At this time, in the light scanning apparatus 100 according to one embodiment, at least one of the following Inequalities (6) and (7) shall be satisfied:

$$- 10 \leq \vert {α}_{3} \vert - \vert {α}_{1} \vert \leq 10 \qquad ( 6 )$$

$$- 10 \leq \vert {α}_{4} \vert - \vert {α}_{2} \vert \leq 10. \qquad ( 7 )$$

When at least one of Inequalities (6) and (7) is satisfied, it is possible to suppress interference between the first to fourth light sources 11 to 41 and to suppress an increase in size of the first to fourth incident optical elements 13 to 43 which are integrally formed with each other.

Specifically, Inequalities (6) and (7) are satisfied since each of |α₁|, |α₂|, |α₃| and |α₄| is 90° in the light scanning apparatus 100 according to the present embodiment.

In the light scanning apparatus 100 according to the present embodiment, the number of deflecting surfaces of the deflecting unit 5 is represented by N, in one embodiment, the following Inequality (8) is to be satisfied:

$$3 < N \leq 6. \qquad ( 8 )$$

If the value exceeds the upper limit value in Inequality (8), a scanning angle by each deflecting surface is reduced, and a size of each deflecting surface is reduced.

Therefore, it is difficult to suppress interference between the first to fourth light sources 11 to 41 and to suppress an increase in size of the first to fourth incident optical elements 13 to 43 which are integrally formed with each other.

In the light scanning apparatus 100 according to the present embodiment, Inequality (8) is satisfied since the number N of deflecting surfaces of the deflecting unit 5 is 4.

FIG. 3B shows a partially enlarged schematic perspective view of a light scanning apparatus 101 according to a modification of the present embodiment.

The light scanning apparatus 101 according to the modification of the present embodiment has the same configuration as the light scanning apparatus 100 according to the present embodiment except that configurations of the first to fourth incident optical systems are different, so that the same members are denoted by the same reference numerals, and the description thereof is omitted.

Specifically, the light scanning apparatus 101 according to the modification of the present embodiment is provided with first, second, third and fourth collimator lenses 135, 235, 335 and 435, first and second prisms 236 and 436, and first and second cylinder lenses 337 and 338.

That is, in the light scanning apparatus 101 according to the modification of the present embodiment, a first light guiding unit is constituted by the first collimator lens 135 and the first cylinder lens 337.

Further, a second light guiding unit is constituted by the second collimator lens 235, the first prism 236 and the second cylinder lens 338, and a third light guiding unit is constituted by the third collimator lens 335 and the first cylinder lens 337.

Furthermore, a fourth light guiding unit is constituted by the fourth collimator lens 435, the second prism 436, and the second cylinder lens 338.

The first and second cylinder lenses 337 and 338 are integrally formed as a compound-eyed optical element.

Each of the first to fourth collimator lenses 135 to 435 has an optical surface that is rotationally symmetrical with respect to the optical axis.

The first to fourth collimator lenses 135 to 435 convert the first and fourth light fluxes, which have been emitted from the first to fourth light sources 11 to 41 and have passed through the first to fourth stops 12 to 42, into parallel light fluxes in the main scanning cross section, respectively.

The first and second prisms 236 and 436 reflect the second and fourth light fluxes that have passed through the second and fourth collimator lenses 235 and 435 so as to bend optical paths of them, and then guide them to the second cylinder lens 338, respectively.

On the other hand, the first and third light fluxes having passed through the first and third collimator lenses 135 and 335 travel to the first cylinder lens 337 without passing through optical elements such as the first and second prisms 236 and 436.

Each of the first and second cylinder lenses 337 and 338 has power in the sub-scanning cross section.

Then, the first cylinder lens 337 guides the first and third light fluxes having passed through the first and third collimator lenses 135 and 335 to the first and second deflecting surfaces 5a and 5b of the deflecting unit 5 with condensing them in the sub-scanning cross section, respectively.

Further, the second cylinder lens 338 guides the second and fourth light fluxes having passed through the first and second prisms 236 and 436 to the first and second deflecting surfaces 5a and 5b of the deflecting unit 5 with condensing them in the sub-scanning cross section, respectively.

In the light scanning apparatus 101 according to the modification of the present embodiment, positions of the first to fourth collimator lenses 135 to 435 can be adjusted with grasping them by jigs from above and below in the sub-scanning direction instead of adjusting positions of the first to fourth light sources 11 to 41 with grasping them by jigs.

That is, all positions of the first to fourth collimator lenses 135 to 435 can be simultaneously adjusted with grasping them by using the jigs in the light scanning apparatus 101 according to the modification of the present embodiment.

Thereby, relative positions between the first to fourth light sources 11 to 41 and the first to fourth collimator lenses 135 to 435 can be easily adjusted.

In addition, in a light scanning apparatus according to another modification of the present embodiment, the first and third collimator lenses 135 and 335 and the first cylinder lens 337 may be formed integrally with each other as an anamorphic optical element having a spherical incident surface and a cylinder exit surface.

Further, in the light scanning apparatus, the second and fourth collimator lenses 235 and 435, the first and second prisms 236 and 436, and the second cylinder lens 338 may be formed integrally with each other. In this case, a composite anamorphic optical element which is a prism having a spherical incident surface and a cylinder exit surface is formed.

As described above, in the light scanning apparatus 100 according to the present embodiment, the first to fourth light sources 11 to 41 are arranged so as not to overlap each other when projected in the main scanning cross section by optimizing the configurations of the first to fourth light sources 11 to 41 and the first to fourth incident optical systems.

Thereby, positions of the first to fourth light sources 11 to 41 can be adjusted with easily grasping them by jigs from above and below in the sub-scanning direction, so that relative positions between the first to fourth light sources 11 to 41 and the first to fourth incident optical elements 13 to 43 can be simply adjusted.

In addition, it is possible to reduce time for assembling and adjusting the light scanning apparatus 100 according to the present embodiment since all positions of the first to fourth light sources 11 to 41 can be simultaneously adjusted with grasping them by using the jigs.

Then, the number of components for assembling and adjusting the light scanning apparatus 100 according to the present embodiment can be reduced, and the number of man-hours for the assembly and adjustment can also be reduced.

In addition, in the light scanning apparatus 100 according to the present embodiment, the first to fourth light sources 11 to 41 can be driven to emit light by a shared driving circuit board since they are appropriately arranged as described above.

Thereby, size and cost of the light scanning apparatus 100 according to the present embodiment can be reduced.

Accordingly, it is possible to provide the light scanning apparatus 100 in which cost reduction and reduction in size and weight are achieved by providing the first to fourth light sources 11 to 41 and the first to fourth incident optical systems such that arrangement adjustment and assembly can be easily performed when they are provided in a small space.

As a result, it is possible to provide a compact light scanning apparatus 100 suitable for high-quality image recording and an image forming apparatus including the light scanning apparatus 100.

### Second Embodiment

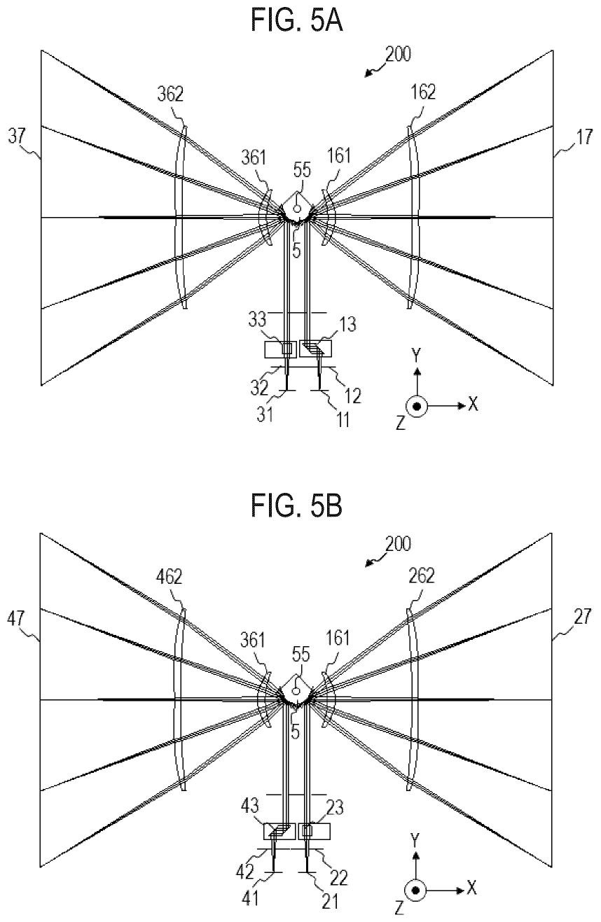

FIGS. 5A and 5B show partially schematic developed views in the main scanning cross section of a light scanning apparatus 200 according to a second embodiment of the present disclosure.

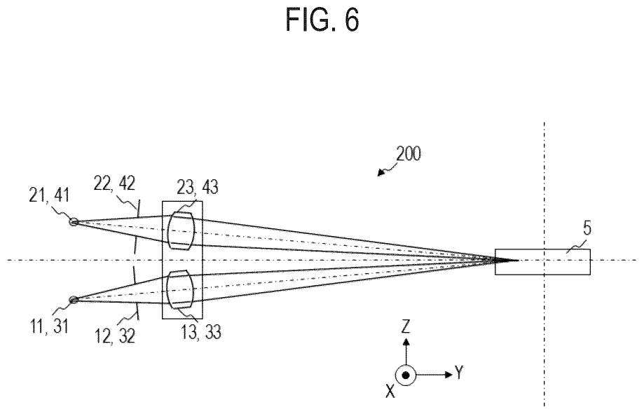

FIG. 6 shows a partial schematic sub-scanning cross sectional view of the light scanning apparatus 200 according to the second embodiment.

The light scanning apparatus 200 according to the present embodiment has the same configuration as that of the light scanning apparatus 100 according to the first embodiment except that shapes of the first to fourth incident optical elements 13 to 43 are different, so that the same members are denoted by the same reference numerals, and the description thereof is omitted.

Further, specification values of the light scanning apparatus 200 according to the present embodiment are shown in the following Table 6.

Arrangements of the first incident optical system and the first imaging optical system provided in the light scanning apparatus 200 according to the present embodiment are shown in the following Table 7, and arrangements of the second incident optical system and the second imaging optical system are shown in the following Table 8.

Shapes of the exit surfaces 134 to 434 of the first to fourth incident optical elements 13 to 43 provided in the light scanning apparatus 200 according to the present embodiment are shown in the following Table 9.

Shapes of the incident surfaces and the exit surfaces of the first scanning imaging elements 161 and 361 and the second scanning imaging elements 162 to 462 provided in the light scanning apparatus 200 according to the present embodiment are shown in the following Table 10.

TABLE 6

| | |
|---|---|
| Wavelengths of first to fourth light fluxes (nm) | 790 |
| Angles α (°) between traveling directions of principal rays | 90 |
| of first to fourth light fluxes immediately before being | |
| incident on deflecting unit 5 and optical axes of first to fourth | |
| imaging optical systems | |
| Number N of deflecting surfaces in deflecting unit 5 | 4 |
| Diameter Φ of deflecting unit 5 (mm) | 20.0 |
| Width of deflecting surface in deflecting unit 5 (mm) | 14.142 |
| Distance between center of deflecting unit 5 and deflecting | 7.071 |
| surface (mm): | |
| X coordinate of rotation center of deflecting unit 5 (mm) | −5.400 |
| Y coordinate of rotation center of deflecting unit 5 (mm) | −4.600 |
| Fθ coefficient (mm/rad) | 142.28 |
| Y coordinate Ymax+ of outermost off-axis image height on | 107.0 |
| positive side (mm) | |
| Y coordinate Ymax− of outermost off-axis image height on | −107.0 |
| negative side (mm) | |
| Printed width Ymax+ − Ymax− (mm) | 214.0 |
| Maximum angle of view θmax+ (°) on positive side | 43.09 |
| Maximum angle of view θmax− (°) on negative side | −43.09 |
| Oblique incident angle β1 (°) formed by traveling direction | 3.0 |
| of principal ray of first light flux immediately before being | |
| incident on deflecting unit 5 with respect to main scanning | |
| cross section in sub-scanning cross section | |
| Oblique incident angle β2 (°) formed by traveling direction | −3.0 |
| of principal ray of second light flux immediately before | |
| being incident on deflecting unit 5 with respect to main | |
| scanning cross section in sub-scanning cross section | |
| Oblique incident angle β3 (°) formed by traveling direction | 3.0 |
| of principal ray of third light flux immediately before being | |
| incident on deflecting unit 5 with respect to main scanning | |
| cross section in sub-scanning cross section | |
| Oblique incident angle β4 (°) formed by traveling direction | −3.0 |
| of principal ray of fourth light flux immediately before being | |
| incident on deflecting unit 5 with respect to main scanning | |
| cross section in sub-scanning cross section | |
| Distance between first light source 11 and second light | 10.80 |
| source 21 in main scanning direction (mm) | |
| Distance between first light source 11 and third light | 10.80 |
| source 31 in main scanning direction (mm) | |
| Distance between first light source 11 and fourth light | 21.60 |
| source 41 in main scanning direction (mm) | |

TABLE 7

| | Surface | | | | | | | | |
|---|---|---|---|---|---|---|---|---|---|
| | number | R | N | x | y | z | gx(x) | gx(y) | gx(z) |
| Light emitting | 1 | 0.000 | 1.5105 | 10.800 | −113.844 | −5.966 | 0.000 | −0.999 | −0.052 |
| point of first light | | | | | | | | | |
| source 11 | | | | | | | | | |
| Exit surface of | 2 | 0.000 | 1.0000 | 10.800 | −113.594 | −5.953 | 0.000 | −0.999 | −0.052 |
| cover glass | | | | | | | | | |
| First stop 12 | 3 | 0.000 | 1.0000 | 10.800 | −98.065 | −5.139 | 0.000 | −0.999 | −0.052 |
| Incident surface | 4 | −12.616 | 1.5240 | 10.800 | −89.877 | −4.710 | 0.000 | −0.999 | −0.052 |
| 131 of first | | | | | | | | | |
| incident optical | | | | | | | | | |
| element 13 | | | | | | | | | |
| First reflecting | 5 | 0.000 | 1.5240 | 10.800 | −86.381 | −4.527 | −0.707 | −0.706 | −0.037 |
| surface 132 of first | | | | | | | | | |
| incident optical | | | | | | | | | |
| element 13 | | | | | | | | | |
| Second reflecting | 6 | 0.000 | 1.5240 | 0.000 | −86.381 | −4.527 | 0.707 | 0.706 | 0.037 |
| surface 133 of first | | | | | | | | | |
| incident optical | | | | | | | | | |
| element 23 | | | | | | | | | |
| Exit surface 134 | 7 | Aspherical | 1.0000 | 0.000 | −82.886 | −4.344 | 0.000 | −0.999 | −0.052 |
| of first incident | | surface | | | | | | | |
| optical element 13 | | | | | | | | | |
| Deflecting unit 5 | 8 | 0.000 | 1.0000 | 1.118 | 1.859 | 0.000 | 0.922 | −0.388 | 0.000 |
| Incident surface of | 9 | Aspherical | 1.5240 | 13.500 | −0.373 | 0.000 | 1.000 | 0.000 | 0.000 |
| first scanning | | surface | | | | | | | |
| imaging element | | | | | | | | | |
| 161 | | | | | | | | | |
| Exit surface of | 10 | Aspherical | 1.0000 | 18.500 | −0.373 | 0.000 | 1.000 | 0.000 | 0.000 |
| first scanning | | surface | | | | | | | |
| imaging element | | | | | | | | | |
| 161 | | | | | | | | | |
| Incident surface of | 11 | Aspherical | 1.5240 | 69.000 | −0.373 | 2.055 | 1.000 | 0.000 | 0.000 |
| second scanning | | surface | | | | | | | |
| imaging element | | | | | | | | | |
| 162 | | | | | | | | | |
| Exit surface of | 12 | Aspherical | 1.0000 | 73.000 | −0.373 | 2.055 | 1.000 | 0.000 | 0.000 |
| second scanning | | surface | | | | | | | |
| imaging element | | | | | | | | | |
| 162 | | | | | | | | | |
| First surface to be | 13 | 0.000 | — | 161.000 | −0.373 | 0.000 | 1.000 | 0.000 | 0.000 |
| scanned 17 | | | | | | | | | |

Size of elliptical shape of first stop 12: 2.00 mm in main scanning direction × 1.24 mm in sub-scanning direction

TABLE 8

| | Surface | | | | | | | | |
|---|---|---|---|---|---|---|---|---|---|
| | number | R | N | x | y | z | gx(x) | gx(y) | gx(z) |
| Light emitting | 1 | 0.000 | 1.5105 | 0.000 | −113.844 | 5.966 | 0.000 | −0.999 | 0.052 |
| point of second | | | | | | | | | |
| light source 21 | | | | | | | | | |
| Exit surface of | 2 | 0.000 | 1.0000 | 0.000 | −113.594 | 5.953 | 0.000 | −0.999 | 0.052 |
| cover glass | | | | | | | | | |
| Second stop 22 | 3 | 0.000 | 1.0000 | 0.000 | −98.065 | 5.139 | 0.000 | −0.999 | 0.052 |
| Incident surface | 4 | −12.616 | 1.5240 | 0.000 | −89.877 | 4.710 | 0.000 | −0.999 | 0.052 |
| 231 of second | | | | | | | | | |
| incident optical | | | | | | | | | |
| element 23 | | | | | | | | | |
| — | 5 | — | — | — | — | — | — | — | — |
| — | 6 | — | — | — | — | — | — | — | — |
| Exit surface 234 | 7 | Aspherical | 1.0000 | 0.000 | −82.886 | 4.344 | 0.000 | −0.999 | 0.052 |
| of second incident | | surface | | | | | | | |
| optical element 23 | | | | | | | | | |
| Deflecting unit 5 | 8 | 0.000 | 1.0000 | 1.118 | 1.859 | 0.000 | 0.922 | −0.388 | 0.000 |
| Incident surface of | 9 | Aspherical | 1.5240 | 13.500 | −0.373 | 0.000 | 1.000 | 0.000 | 0.000 |
| first scanning | | surface | | | | | | | |
| imaging element | | | | | | | | | |
| 161 | | | | | | | | | |
| Exit surface of | 10 | Aspherical | 1.0000 | 18.500 | −0.373 | 0.000 | 1.000 | 0.000 | 0.000 |
| first scanning | | surface | | | | | | | |
| imaging element | | | | | | | | | |
| 161 | | | | | | | | | |
| Incident surface of | 11 | Aspherical | 1.5240 | 69.000 | −0.373 | −2.055 | 1.000 | 0.000 | 0.000 |
| second scanning | | surface | | | | | | | |
| imaging element | | | | | | | | | |
| 262 | | | | | | | | | |
| Exit surface of | 12 | Aspherical | 1.0000 | 73.000 | −0.373 | −2.055 | 1.000 | 0.000 | 0.000 |
| second scanning | | surface | | | | | | | |
| imaging element | | | | | | | | | |
| 262 | | | | | | | | | |
| Second surface to | 13 | 0.000 | − | 161.000 | −0.373 | 0.000 | 1.000 | 0.000 | 0.000 |
| be scanned 27 | | | | | | | | | |

Size of elliptical shape of second stop 22: 2.00 mm in main scanning direction × 1.24 mm in sub-scanning direction

TABLE 9
Exit surfaces 134 to 434 of first to fourth incident optical elements 13 to 43

| Ryu | Kyu | B2u | B4u | B6u | B8u | B10u | B12u |
|---|---|---|---|---|---|---|---|
| 0.00E+00 | 0.00E+00 | 0.00E+00 | 0.00E+00 | 0.00E+00 | 0.00E+00 | 0.00E+00 | 0.00E+00 |
| Ryl | Kyl | B2l | B4l | B6l | B8l | B10l | B12l |
| 0.00E+00 | 0.00E+00 | 0.00E+00 | 0.00E+00 | 0.00E+00 | 0.00E+00 | 0.00E+00 | 0.00E+00 |

| B1 | B3 | B5 | B7 | B9 | B11 |
|---|---|---|---|---|---|
| 0.00E+00 | 0.00E+00 | 0.00E+00 | 0.00E+00 | 0.00E+00 | 0.00E+00 |

| rzu | E2u | E4u | E6u | E8u | E10u | E12u | E14u | E16u |
|---|---|---|---|---|---|---|---|---|
| 4.28E+01 | 0.00E+00 | 0.00E+00 | 0.00E+00 | 0.00E+00 | 0.00E+00 | 0.00E+00 | 0.00E+00 | 0.00E+00 |
| rzl | E2u | E4u | E6u | E8u | E10u | E12l | E14l | E16l |
| 4.28E+01 | 0.00E+00 | 0.00E+00 | 0.00E+00 | 0.00E+00 | 0.00E+00 | 0.00E+00 | 0.00E+00 | 0.00E+00 |

| E1 | E3 | E5 | E7 | E9 |
|---|---|---|---|---|
| 0.00E+00 | 0.00E+00 | 0.00E+00 | 0.00E+00 | 0.00E+00 |

| M0_1 | M1_1 | M2_1 | M3_1 | M4_1 | M5_1 | M6_1 | M7_1 |
|---|---|---|---|---|---|---|---|
| 0.00E+00 | 0.00E+00 | 0.00E+00 | 0.00E+00 | 0.00E+00 | 0.00E+00 | 0.00E+00 | 0.00E+00 |

TABLE 10
Incident surfaces of first scanning imaging elements 161 and 361

| Ryu | Kyu | B2u | B4u | B6u | B8u | B10u | B12u | |
|---|---|---|---|---|---|---|---|---|
| −3.42E+01 | 1.95E+00 | 0.00E+00 | 1.65E−05 | 9.19E−08 | −4.21E−10 | 7.14E−13 | 0.00E+00 | |
| Ryl | Kyl | B2l | B4l | B6l | B8l | B10l | B12l | |
| −3.42E+01 | 1.95E+00 | 0.00E+00 | 1.65E−05 | 9.19E−08 | −4.21E−10 | 7.14E−13 | 0.00E+00 | |
| B1 | B3 | B5 | B7 | B9 | B11 | | | |
| 0.00E+00 | 0.00E+00 | 0.00E+00 | 0.00E+00 | 0.00E+00 | 0.00E+00 | | | |
| rzu | E2u | E4u | E6u | E8u | E10u | E12u | E14u | E16u |
| −1.00E+03 | 0.00E+00 | 0.00E+00 | 0.00E+00 | 0.00E+00 | 0.00E+00 | 0.00E+00 | 0.00E+00 | 0.00E+00 |
| rzl | E2l | E4l | E6l | E8l | E10l | E12l | E14l | E16l |
| −1.00E+03 | 0.00E+00 | 0.00E+00 | 0.00E+00 | 0.00E+00 | 0.00E+00 | 0.00E+00 | 0.00E+00 | 0.00E+00 |
| E1 | E3 | E5 | E7 | E9 | | | | |
| 0.00E+00 | 0.00E+00 | 0.00E+00 | 0.00E+00 | 0.00E+00 | | | | |
| M0_1 | M1_1 | M2_1 | M3_1 | M4_1 | M5_1 | M6_1 | M7_1 | |
| 0.00E+00 | 0.00E+00 | 0.00E+00 | 0.00E+00 | 0.00E+00 | 0.00E+00 | 0.00E+00 | 0.00E+00 | |

Exit surfaces of first scanning imaging elements 161 and 361

| Ryu | Kyu | B2u | B4u | B6u | B8u | B10u | B12u | |
|---|---|---|---|---|---|---|---|---|
| −2.36E+01 | −2.98E+00 | 0.00E+00 | −1.97E−05 | 7.87E−08 | −1.47E−10 | 3.00E−14 | 0.00E+00 | |
| Ryl | Kyl | B2l | B4l | B6l | B8l | B10l | B12l | |
| −2.36E+01 | −2.98E+00 | 0.00E+00 | −1.94E−05 | 7.58E−08 | −1.35E−10 | 1.15E−14 | 0.00E+00 | |
| B1 | B3 | B5 | B7 | B9 | B11 | | | |
| 0.00E+00 | 0.00E+00 | 0.00E+00 | 0.00E+00 | 0.00E+00 | 0.00E+00 | | | |
| rzu | E2u | E4u | E6u | E8u | E10u | E12u | E14u | E16u |
| −1.00E+03 | 0.00E+00 | 0.00E+00 | 0.00E+00 | 0.00E+00 | 0.00E+00 | 0.00E+00 | 0.00E+00 | 0.00E+00 |
| rzl | E2l | E4l | E6l | E8l | E10l | E12l | E14l | E16l |
| −1.00E+03 | 0.00E+00 | 0.00E+00 | 0.00E+00 | 0.00E+00 | 0.00E+00 | 0.00E+00 | 0.00E+00 | 0.00E+00 |
| E1 | E3 | E5 | E7 | E9 | | | | |
| 0.00E+00 | 0.00E+00 | 0.00E+00 | 0.00E+00 | 0.00E+00 | | | | |
| M0_1 | M1_1 | M2_1 | M3_1 | M4_1 | M5_1 | M6_1 | M7_1 | |
| 0.00E+00 | 0.00E+00 | 0.00E+00 | 0.00E+00 | 0.00E+00 | 0.00E+00 | 0.00E+00 | 0.00E+00 | |

Incident surfaces of second scanning imaging element 162 to 462

| Ryu | Kyu | B2u | B4u | B6u | B8u | B10u | B12u | |
|---|---|---|---|---|---|---|---|---|
| −5.24E+02 | 0.00E+00 | 0.00E+00 | 0.00E+00 | 0.00E+00 | 0.00E+00 | 0.00E+00 | 0.00E+00 | |
| Ryl | Kyl | B2l | B4l | B6l | B8l | B10l | B12l | |
| −5.24E+02 | 0.00E+00 | 0.00E+00 | 0.00E+00 | 0.00E+00 | 0.00E+00 | 0.00E+00 | 0.00E+00 | |
| B1 | B3 | B5 | B7 | B9 | B11 | | | |
| 0.00E+00 | 0.00E+00 | 0.00E+00 | 0.00E+00 | 0.00E+00 | 0.00E+00 | | | |
| rzu | E2u | E4u | E6u | E8u | E10u | E12u | E14u | E16u |
| 5.50E+01 | 4.14E−04 | −2.58E−08 | −1.66E−11 | 1.77E−15 | 0.00E+00 | 0.00E+00 | 0.00E+00 | 0.00E+00 |
| rzl | E2l | E4l | E6l | E8l | E10l | E12l | E14l | E16l |
| 5.50E+01 | 4.42E−04 | 2.01E−08 | −8.73E−12 | −2.38E−15 | 0.00E+00 | 0.00E+00 | 0.00E+00 | 0.00E+00 |
| E1 | E3 | E5 | E7 | E9 | | | | |
| 0.00E+00 | 0.00E+00 | 0.00E+00 | 0.00E+00 | 0.00E+00 | | | | |
| M0_1 | M1_1 | M2_1 | M3_1 | M4_1 | M5_1 | M6_1 | M7_1 | |
| 0.00E+00 | 0.00E+00 | 0.00E+00 | 0.00E+00 | 0.00E+00 | 0.00E+00 | 0.00E+00 | 0.00E+00 | |

Exit surfaces of second scanning imaging element 162 to 462

| Ryu | Kyu | B2u | B4u | B6u | B8u | B10u | B12u | |
|---|---|---|---|---|---|---|---|---|
| 8.64E+02 | 1.78E+02 | 0.00E+00 | −9.79E−07 | 1.42E−10 | −1.23E−14 | −5.63E−19 | 0.00E+00 | |
| Ryl | Kyl | B2l | B4l | B6l | B8l | B10l | B12l | |
| 8.64E+02 | 1.78E+02 | 0.00E+00 | −9.79E−07 | 1.42E−10 | −1.23E−14 | −5.63E−19 | 0.00E+00 | |
| B1 | B3 | B5 | B7 | B9 | B11 | | | |
| 0.00E+00 | 0.00E+00 | 0.00E+00 | 0.00E+00 | 0.00E+00 | 0.00E+00 | | | |
| rzu | E2u | E4u | E6u | E8u | E10u | E12u | E14u | E16u |
| −3.21E+01 | 2.97E−05 | 9.42E−10 | 8.06E−13 | 2.66E−16 | 0.00E+00 | 0.00E+00 | 0.00E+00 | 0.00E+00 |
| rzl | E2l | E4l | E6l | E8l | E10l | E12l | E14l | E16l |
| −3.21E+01 | 1.02E−05 | −3.71E−09 | 1.45E−12 | 2.35E−16 | 0.00E+00 | 0.00E+00 | 0.00E+00 | 0.00E+00 |
| E1 | E3 | E5 | E7 | E9 | | | | |
| 0.00E+00 | 0.00E+00 | 0.00E+00 | 0.00E+00 | 0.00E+00 | | | | |
| M0_1 | M1_1 | M2_1 | M3_1 | M4_1 | M5_1 | M6_1 | M7_1 | |
| 0.00E+00 | 0.00E+00 | 0.00E+00 | 0.00E+00 | 0.00E+00 | 0.00E+00 | 0.00E+00 | 0.00E+00 | |

In Tables 9 and 10, “E−X” means 10^{-X}.

Regarding an arrangement of the third incident optical system provided in the light scanning apparatus 200 according to the present embodiment, values shown in Table 8 may be converted so as to be rotationally symmetrical by 180 degrees with respect to a straight line passing through the origin and parallel to the Y direction.

Regarding an arrangement of the fourth incident optical system provided in the light scanning apparatus 200 according to the present embodiment, values shown in Table 7 may be converted so as to be rotationally symmetrical by 180 degrees with respect to the straight line passing through the origin and parallel to the Y direction.

Regarding arrangements of the third imaging optical system and the fourth imaging optical system provided in the light scanning apparatus 200 according to the present embodiment, values shown in Tables 7 and 8 may be converted so as to be symmetrical with respect to a plane that includes the rotation axis 55 of the deflecting unit 5 and is parallel to the Y direction and the Z direction.

A shape (meridional line shape) in the main scanning cross section of each of the exit surfaces 134 to 434 of the first to fourth incident optical elements 13 to 43 provided in the light scanning apparatus 200 according to the present embodiment is expressed by Expression (1) described above.

A shape in the main scanning cross section of each of the incident surfaces and the exit surfaces of the first scanning imaging elements 161 and 361 and the incident surfaces and the exit surfaces of the second scanning imaging elements 162 to 462 provided in the light scanning apparatus 200 according to the present embodiment is also expressed by Expression (1) described above.

A shape (sagittal line shape) in the sub-scanning cross section of each of the exit surfaces 134 to 434 of the first to fourth incident optical elements 13 to 43 provided in the light scanning apparatus 200 according to the present embodiment is expressed by Expressions (2) and (3) described above.

A shape in the sub-scanning cross section of the incident surfaces and the exit surfaces of the first scanning imaging elements 161 and 361 and the incident surfaces and the exit surfaces of the second scanning imaging elements 162 to 462 provided in the light scanning apparatus 200 according to the present embodiment is also expressed by Expressions (2) and (3) described above.

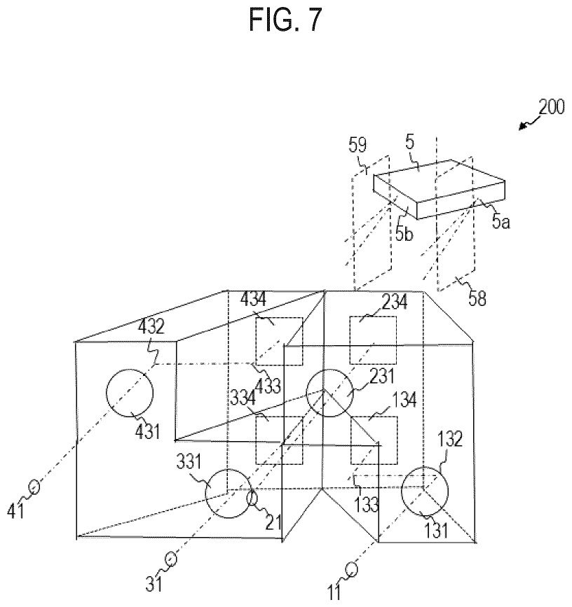

FIG. 7 shows a partially enlarged schematic perspective view of the light scanning apparatus 200 according to the present embodiment.

As shown in FIG. 7, the first and second incident optical elements 13 and 23 are formed integrally with each other as a first compound-eyed optical element in the light scanning apparatus 200 according to the present embodiment.

The third and fourth incident optical elements 33 and 43 are formed integrally with each other as a second compound-eyed optical element.

The first and second compound-eyed optical elements have the same shape as each other, and are arranged so as to be rotationally symmetrical by 180 degrees with respect to a straight line passing through the origin and parallel to the Y direction.

Each of the incident surfaces 131 to 431 of the first to fourth incident optical elements 13 to 43 has a spherical shape that is rotationally symmetrical with respect to the optical axis.

Thereby, the first to fourth light fluxes incident on the incident surfaces 131 to 431 of the first to fourth incident optical elements 13 to 43 are converted into parallel light fluxes in both of the main scanning cross section and the sub-scanning cross section.

The incident surfaces 131 to 431 of the first to fourth incident optical elements 13 to 43 are not limited to those described above, and may have an aspherical shape.

Each of the exit surfaces 134 to 434 of the first to fourth incident optical elements 13 to 43 is an anamorphic surface having power in the sub-scanning cross section, namely has a cylinder shape.

The exit surfaces 134 to 434 of the first to fourth incident optical elements 13 to 43 converge the parallel light fluxes from the incident surfaces 131 to 431 in the sub-scanning cross section, respectively.

In this manner, the first to fourth light fluxes are converged in the sub-scanning cross section by the exit surfaces 134 to 434, respectively, to form line images in the vicinities of the first and second deflecting surfaces 5a and 5b of the deflecting unit 5.

Further, the first incident optical element 13 has first and second reflecting surfaces 132 and 133, and the fourth incident optical element 43 has first and second reflecting surfaces 432 and 433 as shown in FIG. 7.

That is, the first light flux entering from the incident surface 131 is reflected by each of the first and second reflecting surfaces 132 and 133, and then exits from the exit surface 134 in the first incident optical element 13.

In the fourth incident optical element 43, the fourth light flux entering from the incident surface 431 is reflected by each of the first and second reflecting surfaces 432 and 433, and then exits from the exit surface 434.

That is, optical paths of the second and third light fluxes (first and third light fluxes) in the second and third incident optical elements 23 and 33 are straight in the light scanning apparatus 200 according to the present embodiment.

On the other hand, optical paths of the first and fourth light fluxes (second and fourth light fluxes) in the first and fourth incident optical elements 13 and 43 are not straight.

In one embodiment, each of the first and second reflecting surfaces 132 and 133 provided in the first incident optical element 13 and the first and second reflecting surfaces 432 and 433 provided in the fourth incident optical element 43 is a total reflecting surface.

As shown in FIG. 7, principal rays of the first and second light fluxes immediately before being incident on the first deflecting surface 5a of the deflecting unit 5 are in a predetermined plane 58 parallel to the sub-scanning direction in the light scanning apparatus 200 according to the present embodiment.

In other words, the first and second light fluxes emitted from the first and second light sources 11 and 21 are incident on the first deflecting surface 5a of the deflecting unit 5 by the first and second incident optical systems in the light scanning apparatus 200 according to the present embodiment.

Further, principal rays of the third and fourth light fluxes immediately before being incident on the second deflecting surface 5b of the deflecting unit 5 are in a predetermined plane 59 parallel to the sub-scanning direction.

In other words, the third and fourth light fluxes emitted from the third and fourth light sources 31 and 41 are incident on the second deflecting surface 5b of the deflecting unit 5 by the third and fourth incident optical systems in the light scanning apparatus 200 according to the present embodiment.

As shown in FIG. 7, a straight line passing through centers of light emitting surfaces of the first and second light sources 11 and 21 is skewed with respect to the rotation axis 55 of the deflecting unit 5, namely is not parallel to the sub-scanning direction in the light scanning apparatus 200 according to the present embodiment.

Further, a straight line passing through centers of light emitting surfaces of the third and fourth light sources 31 and 41 is also skewed with respect to the rotation axis 55 of the deflecting unit 5, namely is not parallel to the sub-scanning direction.

On the other hand, the straight line passing through the centers of the light emitting surfaces of the first and second light sources 11 and 21 and that passing through the centers of the light emitting surfaces of the third and fourth light sources 31 and 41 are parallel to each other.

In other words, angles formed by the straight line passing through the centers of the light emitting surfaces of the first and second light sources 11 and 21 and the straight line passing through the centers of the light emitting surfaces of the third and fourth light sources 31 and 41 with respect to the sub-scanning direction have the same sign.

Since the centers of the light emitting surfaces of the first to fourth light sources 11 to 41 are arranged on a predetermined plane, the first to fourth light sources 11 to 41 are driven to emit light by a shared light emitting board (not shown).

As shown in FIGS. 5A and 5B, optical path lengths from the centers of the light emitting surfaces of the first to fourth light sources 11 to 41 to the incident surfaces 131 to 431 of the first to fourth incident optical elements 13 to 43 are the same as each other in the light scanning apparatus 200 according to the present embodiment.

Further, all of optical path lengths from the exit surfaces 134 and 234 of the first and second incident optical elements 13 and 23 to an on-axis deflection point on the first deflecting surface 5a, and optical path lengths from the exit surfaces 334 and 434 of the third and fourth incident optical elements 33 and 43 to an on-axis deflection point on the second deflecting surface 5b are the same as each other.

Furthermore, optical path lengths in the first and fourth incident optical elements 13 and 43 are the same as each other, and optical path lengths in the second and third incident optical elements 23 and 33 are the same as each other.

On the other hand, the optical path lengths in the first and fourth incident optical elements 13 and 43 and the optical path lengths in the second and third incident optical elements 23 and 33 are different from each other, and specifically, the latter is smaller than the former.

Therefore, optical path lengths from the centers of the light emitting surfaces of the first and fourth light sources 11 and 41 to the on-axis deflection points on the first and second deflecting surfaces 5a and 5b of the deflecting unit 5 are the same as each other.

Optical path lengths from the centers of the light emitting surfaces of the second and third light sources 21 and 31 to the on-axis deflection points on the first and second deflecting surfaces 5a and 5b of the deflecting unit 5 are the same as each other.

On the other hand, the optical path lengths from the centers of the light emitting surfaces of the first and second light sources 11 and 21 to the on-axis deflection point on the first deflecting surface 5a of the deflecting unit 5 are different from each other.

The optical path lengths from the centers of the light emitting surfaces of the third and fourth light sources 31 and 41 to the on-axis deflection point on the second deflecting surface 5b of the deflecting unit 5 are different from each other.

As shown in FIG. 7, the first and second light sources 11 and 21 are arranged at positions different from each other in the main scanning cross section, and the third and fourth light sources 31 and 41 are also arranged at positions different from each other in the main scanning cross section in the light scanning apparatus 200 according to the present embodiment.

Thereby, arrangements of the first to fourth light sources 11 to 41 and the first to fourth incident optical systems are optimized.

That is, each of the first to fourth light sources 11 to 41 can be easily grasped by a jig from above and below in the sub-scanning direction.

Thereby, relative positions between the first to fourth light sources 11 to 41 and the first to fourth incident optical elements 13 to 43 can be simply adjusted.

Further, it is possible to reduce time for assembling and adjusting the light scanning apparatus 200 according to the present embodiment since all positions of the first to fourth light sources 11 to 41 can be simultaneously adjusted with grasping them by using the jigs.

Then, it is possible to reduce the number of components for assembling and adjusting the light scanning apparatus 200 according to the present embodiment, and it is also possible to reduce the number of man-hours for the assembly and adjustment.

In the light scanning apparatus 200 according to the present embodiment, Inequalities (4), (4a), (5) and (5a) are satisfied since |φ₁|=|φ₂|=42.2°.

Further, in the light scanning apparatus 200 according to the present embodiment, Inequalities (6) and (7) are satisfied since |α₁|, |α₂|, |α₃| and |α₄| are each 90°.

Furthermore, in the light scanning apparatus 200 according to the present embodiment, Inequality (8) is satisfied since N is 4.

As described above, in the light scanning apparatus 200 according to the present embodiment, the first to fourth light sources 11 to 41 are arranged so as not to overlap each other when projected in the main scanning cross section by optimizing the configurations of the first to fourth light sources 11 to 41 and the first to fourth incident optical systems.

Thereby, positions of the first to fourth light sources 11 to 41 can be adjusted with easily grasping them by jigs from above and below in the sub-scanning direction, so that relative positions between the first to fourth light sources 11 to 41 and the first to fourth incident optical elements 13 to 43 can be simply adjusted.

In addition, it is possible to reduce time for assembling and adjusting the light scanning apparatus 200 according to the present embodiment since all positions of the first to fourth light sources 11 to 41 can be simultaneously adjusted with grasping them by using the jigs.

Then, the number of components for assembling and adjusting the light scanning apparatus 200 according to the present embodiment can be reduced, and the number of man-hours for the assembly and adjustment can also be reduced.

In addition, in the light scanning apparatus 200 according to the present embodiment, the first to fourth light sources 11 to 41 can be driven to emit light by a shared driving circuit board since they are appropriately arranged as described above.

Thereby, size and cost of the light scanning apparatus 200 according to the present embodiment can be reduced.

Accordingly, it is possible to provide the light scanning apparatus 200 in which cost reduction and reduction in size and weight are achieved by providing the first to fourth light sources 11 to 41 and the first to fourth incident optical systems such that arrangement adjustment and assembly can be easily performed when they are provided in a small space.

As a result, it is possible to provide a compact light scanning apparatus 200 suitable for high-quality image recording and an image forming apparatus including the light scanning apparatus 200.

### Third Embodiment

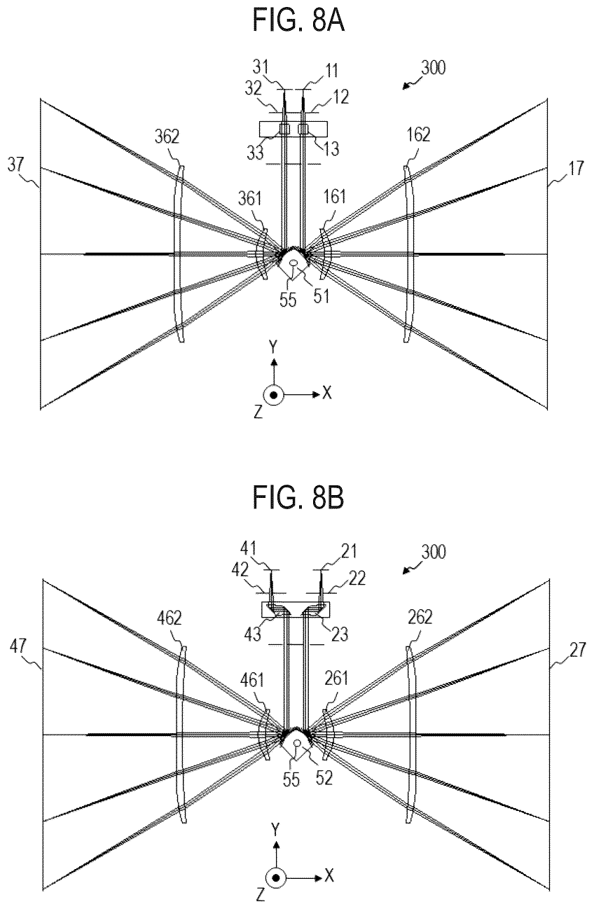

FIGS. 8A and 8B show partially schematic developed views in the main scanning cross section of a light scanning apparatus 300 according to a third embodiment of the present disclosure.

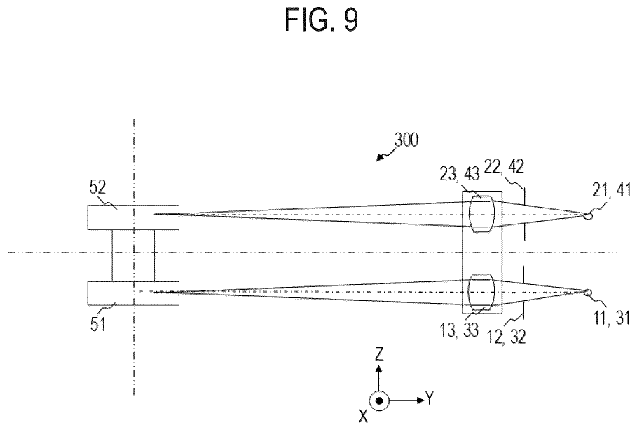

FIG. 9 shows a partial schematic sub-scanning cross sectional view of the light scanning apparatus 300 according to the third embodiment.

The light scanning apparatus 300 according to the present embodiment is different from the light scanning apparatus 100 according to the first embodiment in that first and second deflecting units 51 and 52 are provided instead of the deflecting unit 5.

Further, the light scanning apparatus 300 according to the present embodiment is different from the light scanning apparatus 100 according to the first embodiment in shapes of the first to fourth incident optical elements 13 to 43, and arrangements of the first to fourth light sources 11 to 41 and the first to fourth incident optical systems.

Since the configuration other than the above of the light scanning apparatus 300 according to the present embodiment is the same as that of the light scanning apparatus 100 according to the first embodiment, the same members are denoted by the same reference numerals, and the description thereof is omitted.

Specifically, the light scanning apparatus 300 according to the present embodiment is provided with the first and second deflecting units 51 and 52 that are arrayed in the sub-scanning direction so as to be arranged at the same position as each other when projected in the main scanning cross section, and rotate around the shared rotation axis 55.

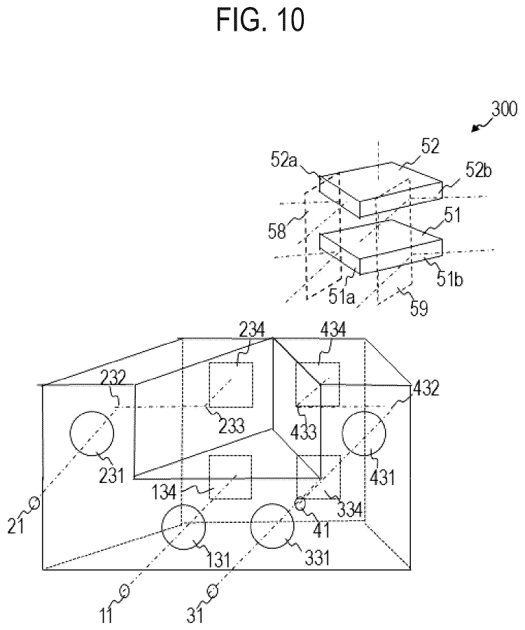

The first and second light fluxes emitted from the first and second light sources 11 and 21 are incident on first deflecting surfaces 51a and 52a of the first and second deflecting units 51 and 52 by the first and second incident optical systems, respectively (FIG. 10).

Further, the third and fourth light fluxes emitted from the third and fourth light sources 31 and 41 are incident on second deflecting surfaces 51b and 52b of the first and second deflecting units 51 and 52 by the third and fourth incident optical systems, respectively (FIG. 10).

In the light scanning apparatus 300 according to the present embodiment, the first and third light fluxes emitted from the first and third light sources 11 and 31 are incident on the first and second deflecting surfaces 51a and 51b of the first deflecting unit 51 in parallel with the main scanning cross section by the first and third incident optical systems, respectively.

Further, in the light scanning apparatus 300 according to the present embodiment, the second and fourth light fluxes emitted from the second and fourth light sources 21 and 41 are incident on the first and second deflecting surfaces 52a and 52b of the second deflecting unit 52 in parallel to the main scanning cross section by the second and fourth incident optical systems, respectively.

Then, the first and second light fluxes deflected by the first deflecting surfaces 51a and 52a of the first and second deflecting units 51 and 52 are guided to the first and second surfaces to be scanned 17 and 27 by the first and second imaging optical systems.

Further, the third and fourth light fluxes deflected by the second deflecting surfaces 51b and 52b of the first and second deflecting units 51 and 52 are guided to the third and fourth surfaces to be scanned 37 and 47 by the third and fourth imaging optical systems.

Specification values of the light scanning apparatus 300 according to the present embodiment are shown in the following Table 11.

Arrangements of the first incident optical system and the first imaging optical system provided in the light scanning apparatus 300 according to the present embodiment are shown in the following Table 12, and arrangements of the second incident optical system and the second imaging optical system provided in the light scanning apparatus 300 according to the present embodiment are shown in the following Table 13.

Shapes of the incident surfaces 131 to 431 and the exit surfaces 134 to 434 of the first to fourth incident optical elements 13 to 43 provided in the light scanning apparatus 300 according to the present embodiment are shown in the following Table 14.

Shapes of the incident surfaces and the exit surfaces of the first scanning imaging elements 161 and 361 and the second scanning imaging elements 162 to 462 provided in the light scanning apparatus 300 according to the present embodiment are shown in the following Table 15.

TABLE 11

| | |
|---|---|
| Wavelengths of first to fourth light fluxes (nm) | 790 |
| Angles α (°) between traveling directions of principal rays | 90 |
| of first to fourth light fluxes immediately before being | |
| incident on deflecting unit 5 and optical axes of first to | |
| fourth imaging optical systems | |
| Number N of deflecting surfaces in first and second deflecting | 4 |
| units 51 and 52 | |
| Diameter Φ of first and second deflecting units 51 and 52 | 20.0 |
| (mm) | |
| Width of deflecting surface in first and second deflecting | 14.142 |
| units 51 and 52 (mm) | |
| Distance between center of first and second deflecting units | 7.071 |
| 51 and 52 and deflecting surface (mm): | |
| X coordinate of rotation center of first and second deflecting | −5.400 |
| units 51 and 52 (mm) | |
| Y coordinate of rotation center of first and second deflecting | −4.600 |
| units 51 and 52 (mm) | |
| Fθ coefficient (mm/rad) | 150.00 |
| Y coordinate Ymax+ of outermost off-axis image height on | 107.0 |
| positive side (mm) | |
| Y coordinate Ymax− of outermost off-axis image height on | −107.0 |
| negative side (mm) | |
| Printed width Ymax+ − Ymax− (mm) | 214.0 |
| Maximum angle of view θmax+ (°) on positive side | 40.87 |
| Maximum angle of view θmax− (°) on negative side | −40.87 |
| Oblique incident angle β1 (°) formed by traveling direction | 0.0 |
| of principal ray of first light flux immediately before being | |
| incident on first deflecting unit 51 with respect to main | |
| scanning cross section in sub-scanning cross section | |
| Oblique incident angle β2 (°) formed by traveling direction | 0.0 |
| of principal ray of second light flux immediately before | |
| being incident on second deflecting unit 52 with respect to | |
| main scanning cross section in sub-scanning cross section | |
| Oblique incident angle β3 (°) formed by traveling direction | 0.0 |
| of principal ray of third light flux immediately before | |
| being incident on first deflecting unit 51 with respect to | |
| main scanning cross section in sub-scanning cross section | |
| Oblique incident angle β4 (°) formed by traveling direction | 0.0 |
| of principal ray of fourth light flux immediately before | |
| being incident on second deflecting unit 52 with respect to | |
| main scanning cross section in sub-scanning cross section | |
| Distance between first light source 11 and second light | 10.80 |
| source 21 in main scanning direction (mm) | |
| Distance between first light source 11 and third light | 10.80 |
| source 31 in main scanning direction (mm) | |
| Distance between first light source 11 and fourth light | 21.60 |
| source 41 in main scanning direction (mm) | |

TABLE 12

| | Surface | | | | | | | | |
|---|---|---|---|---|---|---|---|---|---|
| | number | R | N | x | y | z | gx(x) | gx(y) | gx(z) |
| Light emitting | 1 | 0.000 | 1.5105 | 0.000 | 114.000 | −5.400 | 0.000 | 1.000 | 0.000 |
| point of first light | | | | | | | | | |
| source 11 | | | | | | | | | |
| Exit surface of | 2 | 0.000 | 1.0000 | 0.000 | 113.750 | −5.400 | 0.000 | 1.000 | 0.000 |
| cover glass | | | | | | | | | |
| First stop 12 | 3 | 0.000 | 1.0000 | 0.000 | 98.200 | −5.400 | 0.000 | 1.000 | 0.000 |
| Incident surface | 4 | Aspherical | 1.5240 | 0.000 | 90.000 | −5.400 | 0.000 | 1.000 | 0.000 |
| 131 of first | | surface | | | | | | | |
| incident optical | | | | | | | | | |
| element 13 | | | | | | | | | |
| − | 5 | − | − | − | − | − | − | − | − |
| − | 6 | − | − | − | − | − | − | − | − |
| Exit surface 134 | 7 | Aspherical | 1.0000 | 0.000 | 83.000 | −5.400 | 0.000 | 1.000 | 0.000 |
| of first incident | | surface | | | | | | | |
| optical element 13 | | | | | | | | | |
| First deflecting | 8 | 0.000 | 1.0000 | 0.818 | −1.172 | −5.400 | 0.868 | 0.496 | 0.000 |
| unit 51 | | | | | | | | | |
| Incident surface of | 9 | Aspherical | 1.5240 | 14.800 | 0.000 | −5.400 | 1.000 | 0.000 | 0.000 |
| first scanning | | surface | | | | | | | |
| imaging element | | | | | | | | | |
| 161 | | | | | | | | | |
| Exit surface of | 10 | Aspherical | 1.0000 | 19.800 | 0.000 | −5.400 | 1.000 | 0.000 | 0.000 |
| first scanning | | surface | | | | | | | |
| imaging element | | | | | | | | | |
| 161 | | | | | | | | | |
| Incident surface of | 11 | Aspherical | 1.5240 | 72.800 | 0.000 | −5.400 | 1.000 | 0.000 | 0.000 |
| second scanning | | surface | | | | | | | |
| imaging element | | | | | | | | | |
| 162 | | | | | | | | | |
| Exit surface of | 12 | Aspherical | 1.0000 | 76.800 | 0.000 | −5.400 | 1.000 | 0.000 | 0.000 |
| second scanning | | surface | | | | | | | |
| imaging element | | | | | | | | | |
| 162 | | | | | | | | | |
| First surface to be | 13 | 0.000 | − | 169.800 | 0.000 | −5.400 | 1.000 | 0.000 | 0.000 |
| scanned 17 | | | | | | | | | |

Size of elliptical shape of first stop 12: 2.12 mm in main scanning direction × 2.16 mm in sub-scanning direction

TABLE 13

| | Surface | | | | | | | | |
|---|---|---|---|---|---|---|---|---|---|
| | number | R | N | x | y | z | gx(x) | gx(y) | gx(z) |
| Light emitting | 1 | 0.000 | 1.5105 | 10.800 | 114.000 | 5.400 | 0.000 | 1.000 | 0.000 |
| point of second | | | | | | | | | |
| light source 21 | | | | | | | | | |
| Exit surface of | 2 | 0.000 | 1.0000 | 10.800 | 113.750 | 5.400 | 0.000 | 1.000 | 0.000 |
| cover glass | | | | | | | | | |
| Second stop 22 | 3 | 0.000 | 1.0000 | 10.800 | 98.200 | 5.400 | 0.000 | 1.000 | 0.000 |
| Incident surface | 4 | Aspherical | 1.5240 | 10.800 | 90.000 | 5.400 | 0.000 | 1.000 | 0.000 |
| 231 of second | | surface | | | | | | | |
| incident optical | | | | | | | | | |
| element 23 | | | | | | | | | |
| First reflecting | 5 | 0.000 | 1.5240 | 10.800 | 86.500 | 5.400 | −0.707 | 0.707 | 0.000 |
| surface 232 of | | | | | | | | | |
| second incident | | | | | | | | | |
| optical element 23 | | | | | | | | | |
| Second reflecting | 6 | 0.000 | 1.5240 | 0.000 | 86.500 | 5.400 | 0.707 | −0.707 | 0.000 |
| surface 233 of | | | | | | | | | |
| second incident | | | | | | | | | |
| optical element 23 | | | | | | | | | |
| Exit surface 234 | 7 | Aspherical | 1.0000 | 0.000 | 83.000 | 5.400 | 0.000 | 1.000 | 0.000 |
| of second incident | | surface | | | | | | | |
| optical element 23 | | | | | | | | | |
| Second deflecting | 8 | 0.000 | 1.0000 | 0.818 | −1.172 | 0.000 | 0.868 | 0.496 | 0.000 |
| unit 52 | | | | | | | | | |
| Incident surface of | 9 | Aspherical | 1.5240 | 14.800 | 0.000 | 5.400 | 1.000 | 0.000 | 0.000 |
| first scanning | | surface | | | | | | | |
| imaging element | | | | | | | | | |
| 161 | | | | | | | | | |
| Exit surface of | 10 | Aspherical | 1.0000 | 19.800 | 0.000 | 5.400 | 1.000 | 0.000 | 0.000 |
| first scanning | | surface | | | | | | | |
| imaging element | | | | | | | | | |
| 161 | | | | | | | | | |
| Incident surface of | 11 | Aspherical | 1.5240 | 72.800 | 0.000 | 5.400 | 1.000 | 0.000 | 0.000 |
| second scanning | | surface | | | | | | | |
| imaging element | | | | | | | | | |
| 262 | | | | | | | | | |
| Exit surface of | 12 | Aspherical | 1.0000 | 76.800 | 0.000 | 5.400 | 1.000 | 0.000 | 0.000 |
| second scanning | | surface | | | | | | | |
| imaging element | | | | | | | | | |
| 262 | | | | | | | | | |
| Second surface to | 13 | 0.000 | − | 169.800 | 0.000 | 5.400 | 1.000 | 0.000 | 0.000 |
| be scanned 27 | | | | | | | | | |

Size of elliptical shape of second stop 22: 2.12 mm in main scanning direction × 2.16 mm in sub-scanning direction

TABLE 14
Incident surfaces 131 to 431 of first to fourth incident optical elements 13 to 43

| R | K | C2 | C4 | C6 |
|---|---|---|---|---|
| −1.26E+01 | 0.00E+00 | 0.00E+00 | 1.44E−04 | 0.00E+00 |

Exit surfaces 134 to 434 of first to fourth incident optical elements 13 to 43

| Ryu | Kyu | B2u | B4u | B6u | B8u | B10u | B12u |
|---|---|---|---|---|---|---|---|
| 0.00E+00 | 0.00E+00 | 0.00E+00 | 0.00E+00 | 0.00E+00 | 0.00E+00 | 0.00E+00 | 0.00E+00 |
| Ryl | Kyl | B2l | B4l | B6l | B8l | B10l | B12l |
| 0.00E+00 | 0.00E+00 | 0.00E+00 | 0.00E+00 | 0.00E+00 | 0.00E+00 | 0.00E+00 | 0.00E+00 |

| B1 | B3 | B5 | B7 | B9 | B11 |
|---|---|---|---|---|---|
| 0.00E+00 | 0.00E+00 | 0.00E+00 | 0.00E+00 | 0.00E+00 | 0.00E+00 |

| Rzu | E2u | E4u | E6u | E8u | E10u | E12u | E14u | E16u |
|---|---|---|---|---|---|---|---|---|
| 4.28E+01 | 0.00E+00 | 0.00E+00 | 0.00E+00 | 0.00E+00 | 0.00E+00 | 0.00E+00 | 0.00E+00 | 0.00E+00 |
| Rzl | E2u | E4u | E6u | E8u | E10u | E12l | E14l | E16l |
| 4.28E+01 | 0.00E+00 | 0.00E+00 | 0.00E+00 | 0.00E+00 | 0.00E+00 | 0.00E+00 | 0.00E+00 | 0.00E+00 |

| E1 | E3 | E5 | E7 | E9 |
|---|---|---|---|---|
| 0.00E+00 | 0.00E+00 | 0.00E+00 | 0.00E+00 | 0.00E+00 |

| M0_1 | M1_1 | M2_1 | M3_1 | M4_1 | M5_1 | M6_1 | M7_1 |
|---|---|---|---|---|---|---|---|
| 0.00E+00 | 0.00E+00 | 0.00E+00 | 0.00E+00 | 0.00E+00 | 0.00E+00 | 0.00E+00 | 0.00E+00 |

TABLE 15
Incident surfaces of first scanning imaging elements 161 and 361

| Ryu | Kyu | B2u | B4u | B6u | B8u | B10u | B12u |
|---|---|---|---|---|---|---|---|
| −2.37E+01 | −3.51E+00 | 0.00E+00 | −1.84E−05 | 8.07E−08 | −1.70E−10 | 1.88E−13 | 0.00E+00 |
| Ryl | Kyl | B2l | B4l | B6l | B8l | B10l | B12l |
| −2.37E+01 | −3.51E+00 | 0.00E+00 | −1.84E−05 | 8.07E−08 | −1.70E−10 | 1.88E−13 | 0.00E+00 |

| B1 | B3 | B5 | B7 | B9 | B11 |
|---|---|---|---|---|---|
| 0.00E+00 | 0.00E+00 | 0.00E+00 | 0.00E+00 | 0.00E+00 | 0.00E+00 |

| Rzu | E2u | E4u | E6u | E8u | E10u | E12u | E14u | E16u |
|---|---|---|---|---|---|---|---|---|
| −2.52E+01 | 0.00E+00 | 0.00E+00 | 0.00E+00 | 0.00E+00 | 0.00E+00 | 0.00E+00 | 0.00E+00 | 0.00E+00 |
| Rzl | E2l | E4l | E6l | E8l | E10l | E12l | E14l | E16l |
| −2.52E+01 | 0.00E+00 | 0.00E+00 | 0.00E+00 | 0.00E+00 | 0.00E+00 | 0.00E+00 | 0.00E+00 | 0.00E+00 |

| E1 | | E3 | E5 | | E7 | E9 | |
|---|---|---|---|---|---|---|---|
| 0.00E+00 | | 0.00E+00 | 0.00E+00 | | 0.00E+00 | 0.00E+00 | |
| M0_1 | M1_1 | M2_1 | M3_1 | M4_1 | M5_1 | M6_1 | M7_1 |
| 0.00E+00 | 0.00E+00 | 0.00E+00 | 0.00E+00 | 0.00E+00 | 0.00E+00 | 0.00E+00 | 0.00E+00 |

Exit surfaces of first scanning imaging elements 161 and 361

| Ryu | Kyu | B2u | B4u | B6u | B8u | B10u | B12u |
|---|---|---|---|---|---|---|---|
| −2.36E+01 | −2.98E+00 | 0.00E+00 | −1.97E−05 | 7.87E−08 | −1.47E−10 | 3.00E−14 | 0.00E+00 |
| Ryl | Kyl | B2l | B4l | B6l | B8l | B10l | B12l |
| −2.36E+01 | −2.98E+00 | 0.00E+00 | −1.94E−05 | 7.58E−08 | −1.35E−10 | 1.15E−14 | 0.00E+00 |

| B1 | B3 | B5 | B7 | B9 | B11 |
|---|---|---|---|---|---|
| 0.00E+00 | 0.00E+00 | 0.00E+00 | 0.00E+00 | 0.00E+00 | 0.00E+00 |

| Rzu | E2u | E4u | E6u | E8u | E10u | E12u | E14u | E16u |
|---|---|---|---|---|---|---|---|---|
| −1.00E+03 | 0.00E+00 | 0.00E+00 | 0.00E+00 | 0.00E+00 | 0.00E+00 | 0.00E+00 | 0.00E+00 | 0.00E+00 |
| Rzl | E2l | E4l | E6l | E8l | E10l | E12l | E14l | E16l |
| −1.00E+03 | 0.00E+00 | 0.00E+00 | 0.00E+00 | 0.00E+00 | 0.00E+00 | 0.00E+00 | 0.00E+00 | 0.00E+00 |

| E1 | | E3 | E5 | | E7 | E9 | |
|---|---|---|---|---|---|---|---|
| 0.00E+00 | | 0.00E+00 | 0.00E+00 | | 0.00E+00 | 0.00E+00 | |
| M0_1 | M1_1 | M2_1 | M3_1 | M4_1 | M5_1 | M6_1 | M7_1 |
| 0.00E+00 | 0.00E+00 | 0.00E+00 | 0.00E+00 | 0.00E+00 | 0.00E+00 | 0.00E+00 | 0.00E+00 |

Incident surfaces of second scanning imaging element 162 to 462

| Ryu | Kyu | B2u | B4u | B6u | B8u | B10u | B12u |
|---|---|---|---|---|---|---|---|
| −7.00E+02 | 0.00E+00 | 0.00E+00 | 0.00E+00 | 0.00E+00 | 0.00E+00 | 0.00E+00 | 0.00E+00 |
| Ryl | Kyl | B2l | B4l | B6l | B8l | B10l | B12l |
| −7.00E+02 | 0.00E+00 | 0.00E+00 | 0.00E+00 | 0.00E+00 | 0.00E+00 | 0.00E+00 | 0.00E+00 |

| B1 | B3 | B5 | B7 | B9 | B11 |
|---|---|---|---|---|---|
| 0.00E+00 | 0.00E+00 | 0.00E+00 | 0.00E+00 | 0.00E+00 | 0.00E+00 |

| Rzu | E2u | E4u | E6u | E8u | E10u | E12u | E14u | E16u |
|---|---|---|---|---|---|---|---|---|
| 3.48E+01 | 7.05E−04 | 3.03E−07 | 1.27E−09 | −5.09E−13 | 0.00E+00 | 0.00E+00 | 0.00E+00 | 0.00E+00 |
| Rzl | E2l | E4l | E6l | E8l | E10l | E12l | E14l | E16l |
| 3.48E+01 | 7.05E−04 | 3.03E−07 | 1.27E−09 | −5.09E−13 | 0.00E+00 | 0.00E+00 | 0.00E+00 | 0.00E+00 |

| E1 | | E3 | E5 | | E7 | E9 | |
|---|---|---|---|---|---|---|---|
| 0.00E+00 | | 0.00E+00 | 0.00E+00 | | 0.00E+00 | 0.00E+00 | |
| M0_1 | M1_1 | M2_1 | M3_1 | M4_1 | M5_1 | M6_1 | M7_1 |
| 0.00E+00 | 0.00E+00 | 0.00E+00 | 0.00E+00 | 0.00E+00 | 0.00E+00 | 0.00E+00 | 0.00E+00 |

Exit surfaces of second scanning imaging element 162 to 462

| Ryu | Kyu | B2u | B4u | B6u | B8u | B10u | B12u |
|---|---|---|---|---|---|---|---|
| 5.20E+02 | 9.64E+00 | 0.00E+00 | −9.65E−07 | 1.92E−10 | −2.99E−14 | 2.14E−18 | 0.00E+00 |
| Ryl | Kyl | B2l | B4l | B6l | B8l | B10l | B12l |
| 5.20E+02 | 9.64E+00 | 0.00E+00 | −9.65E−07 | 1.92E−10 | −2.99E−14 | 2.14E−18 | 0.00E+00 |

| B1 | B3 | B5 | B7 | B9 | B11 |
|---|---|---|---|---|---|
| 0.00E+00 | 0.00E+00 | 0.00E+00 | 0.00E+00 | 0.00E+00 | 0.00E+00 |

| Rzu | E2u | E4u | E6u | E8u | E10u | E12u | E14u | E16u |
|---|---|---|---|---|---|---|---|---|
| −8.13E+01 | −1.06E−03 | 7.74E−07 | −2.64E−10 | 3.55E−14 | 0.00E+00 | 0.00E+00 | 0.00E+00 | 0.00E+00 |
| Rzl | E2l | E4l | E6l | E8l | E10l | E12l | E14l | E16l |
| −8.13E+01 | −1.06E−03 | 7.74E−07 | −2.64E−10 | 3.55E−14 | 0.00E+00 | 0.00E+00 | 0.00E+00 | 0.00E+00 |

| E1 | | E3 | E5 | | E7 | E9 | |
|---|---|---|---|---|---|---|---|
| 0.00E+00 | | 0.00E+00 | 0.00E+00 | | 0.00E+00 | 0.00E+00 | |
| M0_1 | M1_1 | M2_1 | M3_1 | M4_1 | M5_1 | M6_1 | M7_1 |
| 0.00E+00 | 0.00E+00 | 0.00E+00 | 0.00E+00 | 0.00E+00 | 0.00E+00 | 0.00E+00 | 0.00E+00 |

In Tables 14 and 15, “E−X” means 10^{-x}.

Regarding arrangements of the third incident optical system and the third imaging optical system provided in the light scanning apparatus 300 according to the present embodiment, values shown in Table 12 may be converted so as to be symmetrical with respect to a plane that includes the rotation axis 55 of the first and second deflecting units 51 and 52 and is parallel to the Y direction and the Z direction.

Similarly, regarding arrangements of the fourth incident optical system and the fourth imaging optical system provided in the light scanning apparatus 300 according to the present embodiment, values shown in Table 13 may be converted so as to be symmetrical with respect to the plane that includes the rotation axis 55 of the first and second deflecting units 51 and 52 and is parallel to the Y direction and the Z direction.

Each of the incident surfaces 131 to 431 of the first to fourth incident optical elements 13 to 43 provided in the light scanning apparatus 300 according to the present embodiment has an aspherical shape that is rotationally symmetrical with respect to the optical axis as expressed by the following Expression (9):

$$X = \frac{\frac{{h}^{2}}{R}}{1 + \sqrt{1 - ( 1 + K ) {( \frac{h}{R} )}^{2}}} + {C}_{2} {h}^{2} + {C}_{4} {h}^{4} + {C}_{6} {h}^{6} . \qquad ( 9 )$$

In Expression (9), h represents a height in a direction perpendicular to the optical axis, R represents a curvature radius, K represents an eccentricity, and Cᵢ (i=2, 4 and 6) are aspherical coefficients.

A shape (meridional line shape) in the main scanning cross section of each of the exit surfaces 134 to 434 of the first to fourth incident optical elements 13 to 43 provided in the light scanning apparatus 300 according to the present embodiment is expressed by Expression (1) described above.

A shape in the main scanning cross section of each of the incident surfaces and the exit surfaces of the first scanning imaging elements 161 and 361 and the incident surfaces and the exit surfaces of the second scanning imaging elements 162 to 462 provided in the light scanning apparatus 300 according to the present embodiment is also expressed by Expression (1) described above.

A shape (sagittal line shape) in the sub-scanning cross section of each of the exit surfaces 134 to 434 of the first to fourth incident optical elements 13 to 43 provided in the light scanning apparatus 300 according to the present embodiment is expressed by Expressions (2) and (3) described above.

A shape in the sub-scanning cross section of each of the incident surfaces and the exit surfaces of the first scanning imaging elements 161 and 361 and the incident surfaces and the exit surfaces of the second scanning imaging elements 162 to 462 provided in the light scanning apparatus 300 according to the present embodiment is also expressed by Expressions (2) and (3) described above.

FIG. 10 shows a partially enlarged schematic perspective view of the light scanning apparatus 300 according to the present embodiment.

As shown in FIG. 10, the first to fourth incident optical elements 13 to 43 are formed integrally with each other as a compound-eyed optical element in the light scanning apparatus 300 according to the present embodiment.

Then, each of the incident surfaces 131 to 431 of the first to fourth incident optical elements 13 to 43 has an aspherical shape that is rotationally symmetrical with respect to the optical axis.

Thereby, the first to fourth light fluxes incident on the incident surfaces 131 to 431 of the first to fourth incident optical elements 13 to 43 are converted into parallel light fluxes in both of the main scanning cross section and the sub-scanning cross section.

Each of the exit surfaces 134 to 434 of the first to fourth incident optical elements 13 to 43 is an anamorphic surface having power in the sub-scanning cross section, namely has a cylinder shape.

Then, the exit surfaces 134 to 434 of the first to fourth incident optical elements 13 to 43 converge the parallel light fluxes from the incident surfaces 131 to 431 in the sub-scanning cross section, respectively.

In this way, the first and second light fluxes are converged in the sub-scanning cross section by the exit surfaces 134 and 234 of the first and second incident optical elements 13 and 23 to form line images in the vicinities of the first deflecting surfaces 51a and 52a of the first and second deflecting units 51 and 52.

Further, the third and fourth light fluxes are converged in the sub-scanning cross section by the exit surfaces 334 and 434 of the third and fourth incident optical elements 33 and 43 to form line images in the vicinities of the second deflecting surfaces 51b and 52b of the first and second deflecting units 51 and 52.

As shown in FIG. 10, the second incident optical element 23 has first and second reflecting surfaces 232 and 233, and the fourth incident optical element 43 has first and second reflecting surfaces 432 and 433.

That is, the second light flux entering from the incident surface 231 is reflected by each of the first and second reflecting surfaces 232 and 233, and then exits from the exit surface 234 in the second incident optical element 23.

Further, the fourth light flux entering from the incident surface 431 is reflected by each of the first and second reflecting surfaces 432 and 433, and then exits from the exit surface 434 in the fourth incident optical element 43.

That is, optical paths of the first and third light fluxes in the first and third incident optical elements 13 and 33 are straight in the light scanning apparatus 300 according to the present embodiment.

On the other hand, optical paths of the second and fourth light fluxes in the second and fourth incident optical elements 23 and 43 are not straight.

In one embodiment, each of the first and second reflecting surfaces 232 and 233 provided in the second incident optical element 23, and the first and second reflecting surfaces 432 and 433 provided in the fourth incident optical element 43 is a total reflecting surface.

As shown in FIG. 10, principal rays of the first and second light fluxes immediately before being incident on the first deflecting surfaces 51a and 52a of the first and second deflecting units 51 and 52 are in a predetermined plane 58 parallel to the sub-scanning direction in the light scanning apparatus 300 according to the present embodiment.

Further, principal rays of the third and fourth light fluxes immediately before being incident on the second deflecting surfaces 51b and 52b of the first and second deflecting units 51 and 52 are in a predetermined plane 59 parallel to the sub-scanning direction.

As shown in FIG. 10, a straight line passing through centers of light emitting surfaces of the first and second light sources 11 and 21 is skewed with respect to the rotation axis 55 of the first and second deflecting units 51 and 52, namely is not parallel to the sub-scanning direction.

Further, a straight line passing through centers of light emitting surfaces of the third and fourth light sources 31 and 41 is also skewed with respect to the rotation axis 55 of the first and second deflecting units 51 and 52, namely is not parallel to the sub-scanning direction.

Then, the centers of the light emitting surfaces of the first to fourth light sources 11 to 41 are arranged on corners of a predetermined trapezoid in a predetermined plane.

In other words, signs of angles formed with respect to the sub-scanning direction by the straight line passing through the centers of the light emitting surfaces of the first and second light sources 11 and 21 and the straight line passing through the centers of the light emitting surfaces of the third and fourth light sources 31 and 41 are different from each other.

Since the centers of the light emitting surfaces of the first to fourth light sources 11 to 41 are arranged on the predetermined plane, the first to fourth light sources 11 to 41 are driven to emit light by a shared light emitting board (not shown).

As shown in FIGS. 8A and 8B, optical path lengths from the centers of the light emitting surfaces of the first to fourth light sources 11 to 41 to the incident surfaces 131 to 431 of the first to fourth incident optical elements 13 to 43 are the same as each other in the light scanning apparatus 300 according to the present embodiment.

Optical path lengths from the exit surfaces 134 and 234 of the first and second incident optical elements 13 and 23 to on-axis deflection points on the first deflecting surfaces 51a and 52a are the same as each other.

Optical path lengths from the exit surfaces 334 and 434 of the third and fourth incident optical elements 33 and 43 to on-axis deflection points on the second deflecting surfaces 51b and 52b are the same as each other, and are also the same as the above-mentioned optical path lengths.

Further, optical path lengths in the first and third incident optical elements 13 and 33 are the same as each other, and optical path lengths in the second and fourth incident optical elements 23 and 43 are the same as each other.

On the other hand, the optical path lengths in the first and third incident optical elements 13 and 33 are different from those in the second and fourth incident optical elements 23 and 43, and specifically, the latter is larger than the former.

Therefore, optical path lengths from the centers of the light emitting surfaces of the first and third light sources 11 and 31 to the on-axis deflection points on the first and second deflecting surfaces 51a and 51b of the first deflecting unit 51 are the same as each other.

Further, optical path lengths from the centers of the light emitting surfaces of the second and fourth light sources 21 and 41 to the on-axis deflection points on the first and second deflecting surfaces 52a and 52b of the second deflecting unit 52 are also the same as each other.

On the other hand, the optical path lengths from the centers of the light emitting surfaces of the first and second light sources 11 and 21 to the on-axis deflection points on the first deflecting surfaces 51a and 52a of the first and second deflecting units 51 and 52 are different from each other.

Further, the optical path lengths from the centers of the light emitting surfaces of the third and fourth light sources 31 and 41 to the on-axis deflection points on the second deflecting surfaces 51b and 52b of the first and second deflecting units 51 and 52 are also different from each other.

In addition, as shown in FIG. 10, the first and second light sources 11 and 21 are arranged at positions different from each other in the main scanning cross section, and the third and fourth light sources 31 and 41 are also arranged at positions different from each other in the main scanning cross section in the light scanning apparatus 300 according to the present embodiment.

Thereby, arrangements of the first to fourth light sources 11 to 41 and the first to fourth incident optical systems are optimized.

That is, each of the first to fourth light sources 11 to 41 can be easily grasped by a jig from above and below in the sub-scanning direction.

Thereby, relative positions between the first to fourth light sources 11 to 41 and the first to fourth incident optical elements 13 to 43 can be simply adjusted.

Further, it is possible to reduce time for assembling and adjusting the light scanning apparatus 300 according to the present embodiment since all positions of the first to fourth light sources 11 to 41 can be simultaneously adjusted with grasping them by using the jigs.

Then, it is possible to reduce the number of components for assembling and adjusting the light scanning apparatus 300 according to the present embodiment, and it is also possible to reduce the number of man-hours for the assembly and adjustment.

In the light scanning apparatus 300 according to the present embodiment, Inequalities (4), (4a), (5) and (5a) are satisfied since |φ₁|=|φ₂|=45.5°.

Further, in the light scanning apparatus 300 according to the present embodiment, Inequalities (6) and (7) are satisfied since |α₁|, |α₂|, |α₃| and |α₄| are each 90°.

Furthermore, in the light scanning apparatus 300 according to the present embodiment, Inequality (8) is satisfied since N is 4.

As described above, in the light scanning apparatus 300 according to the present embodiment, the first to fourth light sources 11 to 41 are arranged so as not to overlap each other when projected in the main scanning cross section by optimizing the configurations of the first to fourth light sources 11 to 41 and the first to fourth incident optical systems.

Thereby, positions of the first to fourth light sources 11 to 41 can be adjusted with easily grasping them by jigs from above and below in the sub-scanning direction, so that relative positions between the first to fourth light sources 11 to 41 and the first to fourth incident optical elements 13 to 43 can be simply adjusted.

In addition, it is possible to reduce time for assembling and adjusting the light scanning apparatus 300 according to the present embodiment since all positions of the first to fourth light sources 11 to 41 can be simultaneously adjusted with grasping them by using the jigs.

Then, the number of components for assembling and adjusting the light scanning apparatus 300 according to the present embodiment can be reduced, and the number of man-hours for the assembly and adjustment can also be reduced.

In addition, in the light scanning apparatus 300 according to the present embodiment, the first to fourth light sources 11 to 41 can be driven to emit light by a shared driving circuit board since they are appropriately arranged as described above.

Thereby, size and cost of the light scanning apparatus 300 according to the present embodiment can be reduced.

Accordingly, it is possible to provide the light scanning apparatus 300 in which cost reduction and reduction in size and weight are achieved by providing the first to fourth light sources 11 to 41 and the first to fourth incident optical systems such that arrangement adjustment and assembly can be easily performed when they are provided in a small space.

As a result, it is possible to provide a compact light scanning apparatus 300 suitable for high-quality image recording and an image forming apparatus including the light scanning apparatus 300.

According to the present disclosure, a light scanning apparatus capable of simply adjusting relative positions between a plurality of light sources and a plurality of light guiding units can be provided.

### Image Forming Apparatus

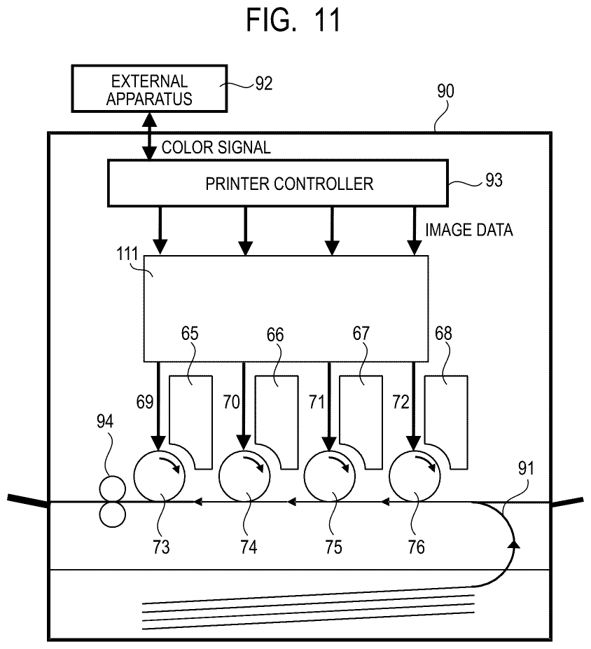

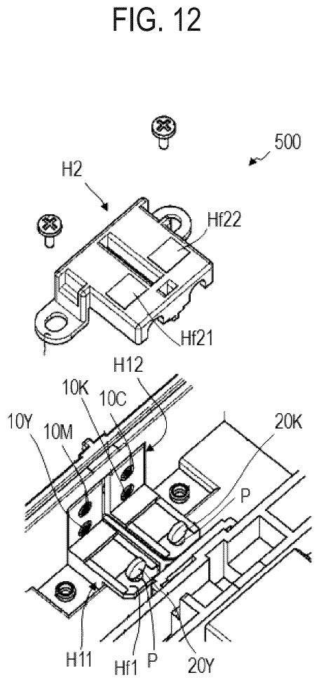

FIG. 11 shows a sub-scanning cross sectional view of a main part of an image forming apparatus 90 in which a light scanning apparatus 111 according to any one of the first to third embodiments of the present disclosure is mounted.

The image forming apparatus 90 is a tandem-type color image forming apparatus that records image information on a surface of each photosensitive drum serving as an image bearing body by using the light scanning apparatus 111 according to any one of the first to third embodiments of the present disclosure.

The image forming apparatus 90 includes the light scanning apparatus 111 according to any one of the first to third embodiments of the present disclosure, photosensitive drums (photosensitive bodies) 73, 74, 75 and 76 as image bearing bodies, and developing units 65, 66, 67 and 68.

Further, the image forming apparatus 90 includes a conveying belt 91, a printer controller 93, and a fixing unit 94.

Color signals (code data) of R (red), G (green), and B (blue) output from an external apparatus 92 such as a personal computer are input to the image forming apparatus 90.

Next, the input color signals are converted into image data (dot data) of C (cyan), M (magenta), Y (yellow), and K (black) by the printer controller 93 in the image forming apparatus 90.

The converted image data is input to the light scanning apparatus 111, and light beams 69, 70, 71 and 72 modulated in accordance with the image data are emitted from the light scanning apparatus 111.

Thereby, photosensitive surfaces of the photosensitive drums 73 to 76 are exposed to the light beams 69 to 72, respectively.

In the image forming apparatus 90, charging rollers (not shown) for uniformly charging the surfaces of the photosensitive drums 73 to 76 are provided so as to abut on the surfaces.

Then, the surfaces of the photosensitive drums 73 to 76 charged by the charging rollers are irradiated with the light beams 69 to 72 by the light scanning apparatus 111.

As described above, the light beams 69 to 72 are modulated on the basis of the image data of the respective colors, and electrostatic latent images are formed on the surfaces of the photosensitive drums 73 to 76 by irradiation with the light beams 69 to 72.

The formed electrostatic latent images are developed as toner images by the developing units 65 to 68 arranged so as to abut on the photosensitive drums 73 to 76.

The toner images developed by the developing units 65 to 68 are multiply transferred onto a sheet (transferred material) (not shown) conveyed on the conveying belt 91 by a transferring roller (transferring unit) (not shown) arranged to face the photosensitive drums 73 to 76. Thereby, one full-color image is formed.

The sheet on which the unfixed toner image has been transferred as described above is further conveyed to a fixing unit 94 behind the photosensitive drums 73 to 76 (on the left side in FIG. 11).

The fixing unit 94 is formed by a fixing roller having a fixing heater (not shown) therein and a pressurizing roller arranged so as to come into pressure contact with the fixing roller.

Then, the sheet conveyed from the transferring portion is heated with being pressed at the pressure contact portion between the fixing roller and the pressurizing roller, thereby the unfixed toner image on the sheet is fixed.

Further, a sheet discharging roller (not shown) is arranged behind the fixing unit 94, and the sheet discharging roller discharges the sheet on which the toner image is fixed to outside of the image forming apparatus 90.

The image forming apparatus 90 records an image signal (image information) on the photosensitive surface of each of the photosensitive drums 73 to 76 corresponding to each color of C, M, Y and K by using the light scanning apparatus 111 to print a color image at a high speed.

As the external apparatus 92, for example, a color image reading apparatus including a CCD sensor may be used.

In this case, a color digital copier is formed by the color image reading apparatus and the image forming apparatus 90.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-029685, filed Feb. 27, 2025, which is hereby incorporated by reference herein in its entirety.

What is claimed is:

1. An apparatus, comprising:
a deflecting unit including a first deflecting surface configured to deflect first and second light fluxes from first and second light sources to scan first and second surfaces in a main scanning direction, respectively; and
first and second light guiding units configured to guide the first and second light fluxes from the first and second light sources to the first deflecting surface, respectively,
wherein an optical path of the first light flux in the first light guiding unit includes a straight line connecting the first light source and the first deflecting surface, and
wherein an optical path of the second light flux in the second light guiding unit does not include a straight line connecting the second light source and the first deflecting surface.

2. An apparatus, comprising:
a deflecting unit including a first deflecting surface configured to deflect first and second light fluxes from first and second light sources to scan first and second surfaces in a main scanning direction, respectively; and
first and second light guiding units configured to guide the first and second light fluxes from the first and second light sources to the first deflecting surface, respectively,
wherein an optical path of the first light flux in the first light guiding unit includes a straight line connecting the first light source and the first deflecting surface, and
wherein a first straight line passing through centers of light emitting surfaces of the first and second light sources is not parallel to a sub-scanning direction.

3. The apparatus according to claim 2, wherein the following inequality is satisfied:
$$30. \leq \vert {ϕ}_{1} \vert \leq 60.$$
where φ₁ (°) represents a first angle formed by the first straight line with respect to the sub-scanning direction.

4. The apparatus according to claim 1, wherein the second light guiding unit includes first and second reflecting surfaces each of which reflects the second light flux.

5. The apparatus according to claim 4,
wherein the first light guiding unit includes a first incident surface on which the first light flux from the first light source is incident, and a first exit surface from which the first light flux from the first incident surface exits, and
wherein the second light guiding unit includes a second incident surface on which the second light flux from the second light source is incident, and a second exit surface from which the second light flux reflected by the first and second reflecting surfaces exits.

6. The apparatus according to claim 5, wherein an optical path length of a principal ray of the first light flux from the first incident surface to the first exit surface, and an optical path length of a principal ray of the second light flux from the second incident surface to the second exit surface are different from each other.

7. The apparatus according to claim 6, wherein an optical path length of the principal ray of the first light flux from the first light source to the first incident surface, and an optical path length of the principal ray of the second light flux from the second light source to the second incident surface are the same as each other.

8. The apparatus according to claim 7, wherein an optical path length of the principal ray of the first light flux from the first exit surface to a first on-axis deflection point on the first deflecting surface, and an optical path length of the principal ray of the second light flux from the second exit surface to the first on-axis deflection point are the same as each other.

9. The apparatus according to claim 5, wherein each of the first and second incident surfaces is an aspherical surface which is rotationally symmetrical with respect to an optical axis.

10. The apparatus according to claim 1, wherein the first and second light guiding units are integrated with each other.

11. The apparatus according to claim 1,
wherein the deflecting unit includes a second deflecting surface configured to deflect third and fourth light fluxes from third and fourth light sources to scan third and fourth surfaces in the main scanning direction, respectively,
wherein the apparatus comprises third and fourth light guiding units configured to guide the third and fourth light fluxes from the third and fourth light sources to the second deflecting surface, respectively,
wherein an optical path of the third light flux in the third light guiding unit includes a straight line connecting the third light source and the second deflecting surface, and
wherein an optical path of the fourth light flux in the fourth light guiding unit does not include a straight line connecting the fourth light source and the second deflecting surface.

12. The apparatus according to claim 2,
wherein the deflecting unit includes a second deflecting surface configured to deflect third and fourth light fluxes from third and fourth light sources to scan third and fourth surfaces in the main scanning direction, respectively,
wherein the apparatus comprises third and fourth light guiding units configured to guide the third and fourth light fluxes from the third and fourth light sources to the second deflecting surface, respectively,
wherein an optical path of the third light flux in the third light guiding unit includes a straight line connecting the third light source and the second deflecting surface, and
wherein a second straight line passing through centers of light emitting surfaces of the third and fourth light sources is not parallel to the sub-scanning direction.

13. The apparatus according to claim 12, wherein the following inequalities are satisfied:
$$30. \leq \vert {ϕ}_{1} \vert \leq 60.$$
$$30. \leq \vert {ϕ}_{2} \vert \leq 60. .$$
where φ₁ (°) represents a first angle formed by the first straight line with respect to the sub-scanning direction, and φ₂ (°) represents a second angle formed by the second straight line with respect to the sub-scanning direction.

14. The apparatus according to claim 11, wherein the fourth light guiding unit includes third and fourth reflecting surfaces each of which reflects the fourth light flux.

15. The apparatus according to claim 14,
wherein the third light guiding unit includes a third incident surface on which the third light flux from the third light source is incident, and a third exit surface from which the third light flux from the third incident surface exits,
wherein the fourth light guiding unit includes a fourth incident surface on which the fourth light flux from the fourth light source is incident, and a fourth exit surface from which the fourth light flux reflected by the third and fourth reflecting surfaces exits, and
wherein an optical path length of a principal ray of the third light flux from the third incident surface to the third exit surface, and an optical path length of a principal ray of the fourth light flux from the fourth incident surface to the fourth exit surface are different from each other.

16. The apparatus according to claim 15,
wherein an optical path length of the principal ray of the third light flux from the third light source to the third incident surface, and an optical path length of the principal ray of the fourth light flux from the fourth light source to the fourth incident surface are the same as each other, and
wherein an optical path length of the principal ray of the third light flux from the third exit surface to a second on-axis deflection point on the second deflecting surface, and an optical path length of the principal ray of the fourth light flux from the fourth exit surface to the second on-axis deflection point are the same as each other.

17. The apparatus according to claim 11, wherein the first to fourth light guiding units are integrated with each other.

18. An apparatus, comprising:
first and second deflecting units including first and second deflecting surfaces configured to deflect first and second light fluxes from first and second light sources to scan first and second surfaces in a main scanning direction, respectively; and
first and second light guiding units configured to guide the first and second light fluxes from the first and second light sources to the first and second deflecting surfaces, respectively,
wherein first and second on-axis deflection points on the first and second deflecting surfaces are on a plane parallel to a sub-scanning direction,
wherein an optical path of the first light flux in the first light guiding unit includes a straight line connecting the first light source and the first deflecting surface, and
wherein an optical path of the second light flux in the second light guiding unit does not include a straight line connecting the second light source and the second deflecting surface.

19. An image forming apparatus, comprising:
the apparatus according to claim 1; and
a developing unit configured to develop electrostatic latent images formed on the first and second surfaces by the apparatus.

20. An image forming apparatus, comprising:
the apparatus according to claim 1; and
a controller configured to convert a signal output from an external apparatus into image data to input the image data to the apparatus.
